(19) United States
(12) Patent Application Publication
(10) Pub. No.: US 2025/0070860 A1
(43) Pub. Date: Feb. 27, 2025

(54) METHODS, COMMUNICATIONS DEVICES, AND NON-TERRESTRIAL INFRASTRUCTURE EQUIPMENT

(71) Applicant: Sony Group Corporation, Tokyo (JP)

(72) Inventors: Yassin Aden AWAD, Basingstoke (GB); Vivek SHARMA, Basingstoke (GB); Yuxin WEI, Basingstoke (GB); Hideji WAKABAYASHI, Basingstoke (GB)

(73) Assignee: Sony Group Corporation, Tokyo (JP)

(21) Appl. No.: 18/726,839

(22) PCT Filed: Jan. 5, 2023
(86) PCT No.: PCT/EP2023/050184

§ 371 Date: Jul. 5, 2024

(30) Foreign Application Priority Data
Jan. 12, 2022 (EP) 22151235.3

(51) Int. Cl. H04B 7/185; H04W 4/44; H04W 84/06

(52) U.S. Cl. CPC H04B 7/18513; H04W 4/44; H04W 84/06

(57) ABSTRACT

A method of operating a communications device for transmitting signals to and/or receiving signals from a non-terrestrial network, NTN, while the communications device is in an inactive state is provided. The method comprises commencing a small data transmission, SDT, failure timer setting a time period during which the communications device can communicate one or more SDTs with the NTN when the communications device is located inside a coverage area provided by the NTN. The method comprises determining that the communications device is expected to enter a coverage gap before the SDT failure timer expires. The coverage gap is a time period during which the communications device is located outside the coverage area provided by the NTN. The method comprises adjusting the commenced SDT failure timer based on an estimate of the coverage gap.

### BACKGROUND

### Field of Disclosure

The present disclosure relates to communications devices, non-terrestrial infrastructure equipment and methods of operating communications devices and non-terrestrial infrastructure equipment while the communications device is in an inactive state.

The present application claims the Paris Convention priority of European patent application number EP 22151235.3, the contents of which are hereby incorporated by reference in their entirety.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Third and fourth generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these and future networks, i.e. geographic locations where access to the networks is possible, may be expected to increase ever more rapidly.

Current and future wireless communications networks are expected to routinely and efficiently support communications with a wider range of devices associated with a wider range of data traffic profiles and types than previously developed systems are optimised to support. For example, it is expected that future wireless communications networks will be expected to efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance.

In view of this there is expected to be a desire for more advanced wireless communications networks, for example those which may be referred to as 5G or new radio (NR) system/new radio access technology (RAT) systems, as well as future iterations/releases of existing systems, to efficiently support connectivity for a wide range of devices associated with different applications and different characteristic data traffic profiles.

One example area of current interest in this regard includes so-called “non-terrestrial networks”, or NTN for short. 3GPP has proposed in Release 15 of the 3GPP specifications to develop technologies for providing coverage by means of one or more antennas mounted on airborne or space-borne vehicles [1]. Non-terrestrial networks may provide service in areas that cannot be covered by terrestrial cellular networks (i.e. those where coverage is provided by means of land-based antennas), such as isolated or remote areas, on board aircraft or vessels) or may provide enhanced service in other areas. The expanded coverage that may be achieved by means of non-terrestrial networks may provide service continuity for machine-to-machine (M2M) or ‘internet of things’ (IoT) devices, or for passengers on board moving platforms (e.g. passenger vehicles such as aircraft, ships, high speed trains, or buses). Other benefits may arise from the use of non-terrestrial networks for providing multicast/broadcast resources for data delivery.

The use of different types of network infrastructure equipment and requirements for coverage enhancement give rise to new challenges for efficiently handling communications in wireless communications systems that need to be addressed.

### SUMMARY OF THE DISCLOSURE

The present disclosure can help address or mitigate at least some of the issues discussed above.

Embodiments can provide a method of operating a communications device for transmitting signals to and/or receiving signals from a non-terrestrial network, NTN, while the communications device is in an inactive state. The method comprises commencing a small data transmission, SDT, failure timer setting a time period during which the communications device can communicate one or more SDTs with the NTN when the communications device is located inside a coverage area provided by the NTN. The method comprises determining that the communications device is expected to enter a coverage gap before the SDT failure timer expires. The coverage gap is a time period during which the communications device is located outside the coverage area provided by the NTN. The method comprises adjusting the commenced SDT failure timer based on an estimate of the coverage gap.

Embodiments can provide a method of operating non-terrestrial network, NTN, infrastructure equipment for transmitting signals to and/or receiving signals from a communications device while the communications device is in an inactive state. The method comprises providing a coverage area for communicating one or more small data transmissions, SDTs, with the communications device when the communications device is located inside the coverage area. The NTN infrastructure equipment can communicate the one or more SDTs with the communications device during a time period set by an SDT failure timer commenced by the communications device. The method comprises transmitting, to the communications device, information for determining that the communications device is expected to enter a coverage gap before the SDT failure timer expires. The method comprises determining that the SDT failure timer has been adjusted by the communications device.

Embodiments can improve communications efficiency and reduce power consumption in communications devices communicating with an NTN in an inactive state. By adjusting the SDT failure timer based on the estimated coverage gap, a situation in which the SDT failure timer expires during the coverage gap can be prevented. Consequently, the increased signalling and power consumption associated with re-establishing an SDT session with the NTN can be avoided. Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device configured in accordance with example embodiments;

FIG. 4 schematically shows an example of a communications device in a non-terrestrial network which may be configured to operate in accordance with embodiments of the present disclosure;

FIG. 5 is reproduced from [1], and illustrates a first example of a non-terrestrial network featuring an access networking service based on a satellite/aerial platform with a bent pipe payload;

FIG. 6 is reproduced from [1], and illustrates a second example of an NTN featuring an access networking service based on a satellite/aerial platform connected to a gNodeB;

FIGS. 7A and 7B illustrate how uplink small data transmissions (SDT) may be performed by a user equipment (UE) using random access (RACH) schemes while the UE is in an inactive state;

FIG. 8 schematically illustrates an SDT failure timer expiring during a coverage gap in an NTN;

FIG. 9 is a flow diagram illustrating a method performed by a communications device in accordance with example embodiments;

FIG. 10 is a flow diagram illustrating an extension of an SDT failure timer operating according to Opt 1 in accordance with example embodiments;

FIG. 11 is a flow diagram illustrating an extension of an SDT failure timer operating according to Opt 2 in accordance with example embodiments;

FIG. 12 is a flow diagram illustrating a method performed by NTN infrastructure equipment in accordance with example embodiments;

### DETAILED DESCRIPTION OF THE EMBODIMENTS

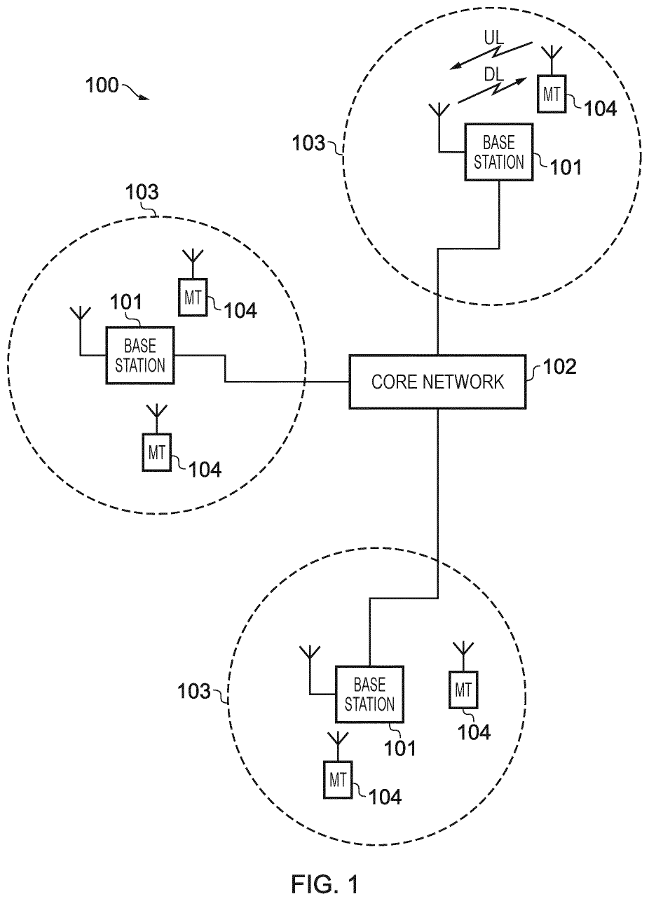

Long Term Evolution Advanced Radio Access Technology (4G) FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [2]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104. Data is transmitted from the base stations 101 to the communications devices 104 within their respective coverage areas 103 via a radio downlink. Data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs (eNB), g-nodeBs (gNB) and so forth. In this regard, different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G NR)

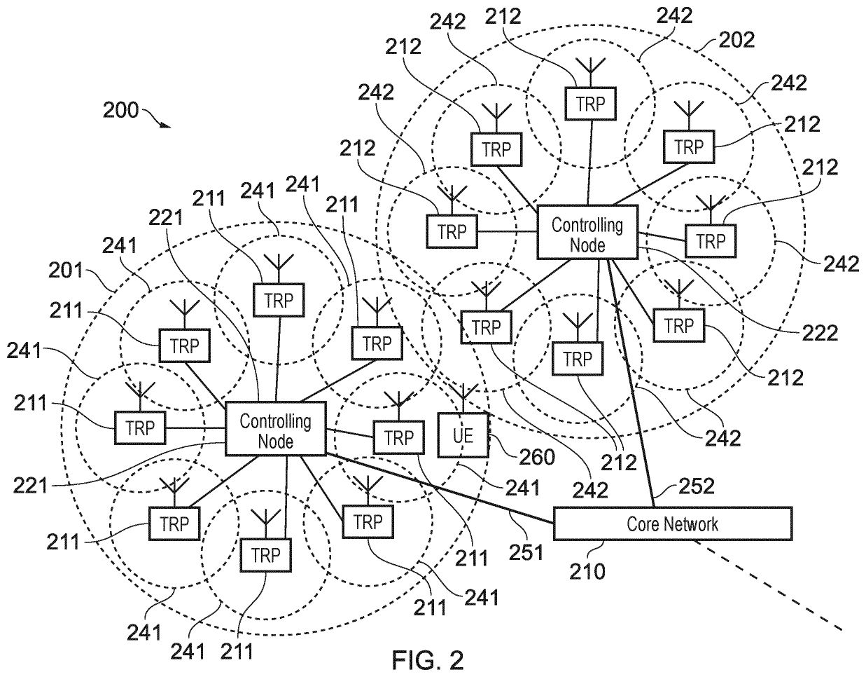

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units (DUs) 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases, communications for a given communications device are routed through only one of the distributed units, but it will be appreciated in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated the specific wireless communications architecture in any given implementation is not of primary significance to the principles described herein.

In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

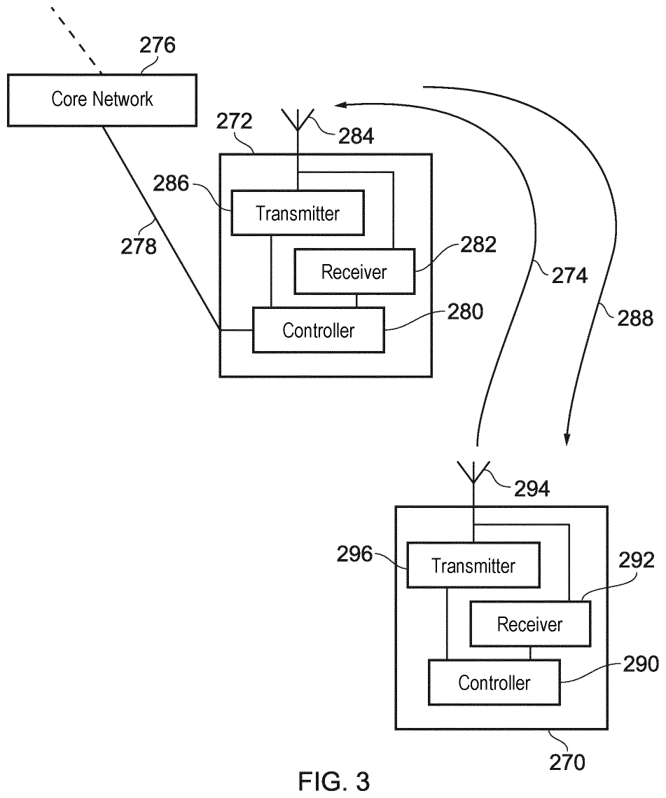

A more detailed illustration of a communications device 270 and an example network infrastructure equipment 272, which may be thought of as an eNB or a gNB 101 or a combination of a controlling node 221 and TRP 211, is presented in FIG. 3. As shown in FIG. 3, the communications device 270 is shown to transmit uplink data to the infrastructure equipment 272 of a wireless access interface as illustrated generally by an arrow 274. The UE 270 is shown to receive downlink data transmitted by the infrastructure equipment 272 via resources of the wireless access interface as illustrated generally by an arrow 288. As with FIGS. 1 and 2, the infrastructure equipment 272 is connected to a core network 276 (which may correspond to the core network 102 of FIG. 1 or the core network 210 of FIG. 2) via an interface 278 to a controller 280 of the infrastructure equipment 272. The infrastructure equipment 272 may additionally be connected to other similar infrastructure equipment by means of an inter-radio access network node interface, not shown on FIG. 3.

The infrastructure equipment 272 includes a receiver 282 connected to an antenna 284 and a transmitter 286 connected to the antenna 284. Correspondingly, the communications device 270 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the communications device 270 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 270 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random access memory, which may be non-volatile memory, operating according to instructions stored on a computer readable medium.

### Non-Terrestrial Networks (NTNs)

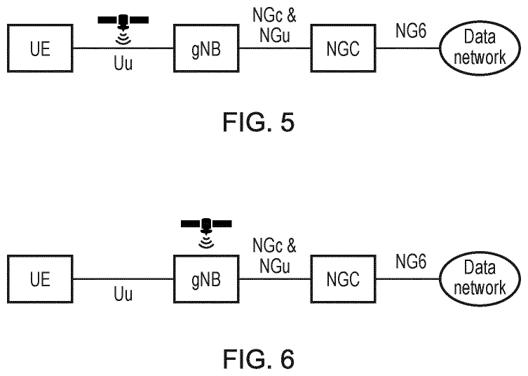

An overview of NR-NTN can be found in [1], and much of the following wording, along with FIGS. 5 and 6 below, has been reproduced from that document as a way of background.

An NTN aerial vehicle (such as a satellite or aerial platform) may allow a connection of a communications device and a ground station (which may be referred to herein as an NTN gateway). In the present disclosure, the term NTN aerial vehicle is used to refer to a space vehicle, aerial platform, or satellite, or any other entity which moves relative to a communications device and is configured to communicate with a communications device. In particular, an NTN aerial vehicle may be in some embodiments a low earth orbit (LEO) satellite, a medium earth orbit (MEO) satellite, a high altitude platform system (HAPS), a balloon or a drone for example.

As a result of the wide service coverage capabilities and reduced vulnerability of space/airborne vehicles to physical attacks and natural disasters, Non-Terrestrial Networks are expected to:
foster the roll out of 5G service in un-served areas that cannot be covered by a terrestrial 5G network (isolated/remote areas, on board aircrafts or vessels) and underserved areas (e.g. sub-urban/rural areas) to upgrade the performance of limited terrestrial networks in a cost effective manner;
reinforce the 5G service reliability by providing service continuity for M2M/IoT devices or for passengers on board moving platforms (e.g. passenger vehicles-aircraft, ships, high speed trains, bus) or ensuring service availability anywhere especially for critical communications, future railway/maritime/aeronautical communications; and to
enable 5G network scalability by providing efficient multicast/broadcast resources for data delivery towards the network edges or even user terminal.

The benefits relate to either Non-Terrestrial Networks (NTNs) operating alone or to integrated terrestrial and Non-Terrestrial networks. They will impact at least coverage, user bandwidth, system capacity, service reliability or service availability, energy consumption and connection density. A role for NTN components in the 5G system is expected for at least the following verticals: transport, Public Safety, Media and Entertainment, eHealth, Energy, Agriculture, Finance and Automotive. It should also be noted that the same NTN benefits apply to 4G and/or LTE technologies and that while NR is sometimes referred to in the present disclosure, the teachings and techniques presented herein are equally applicable to 4G and/or LTE.

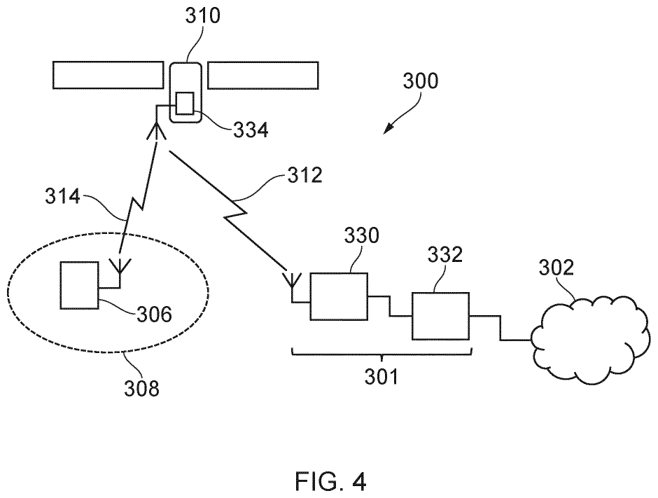

FIG. 4 schematically shows an example of a communications device 306 communicating with an NTN 300. The NTN 300 in FIG. 4 is based broadly around an LTE-type or NR-type architecture. Many aspects of the operation of the NTN 300 are known and understood and are not described here in detail in the interest of brevity. Operational aspects of the NTN which are not specifically described herein may be implemented in accordance with any known techniques, for example according to the current LTE-standards or the proposed NR standards.

The NTN 300 comprises a core network part 302 (which may be a 4G core network or a 5G core network) in communicative connection with a radio network part 301. The radio network part 301 comprises a base station 332 connected to a ground station (or NTN gateway) 330. The radio network part 301 may perform the functions of a base station 101 of FIG. 1, or may perform the functions of a controlling node and TRP of FIG. 2.

The NTN 300 comprises an NTN aerial vehicle 310 which includes communications circuitry 334 for communicating with the communications device 306 and radio network part 301 via wireless communications links 314, 312.

The communications device 306 is located within a coverage area (or cell) 308 provided by the NTN 300. In the example shown in FIG. 4, the coverage area 308 is provided a spot beam generated by the communications circuitry 334 of the NTN aerial vehicle 310. The boundary of the cell 308 may depend on an altitude of the NTN aerial vehicle 310 and a configuration of one or more antennas of the communications circuitry 334 by which the communications circuitry 334 transmits and receives signals from the communications device 306.

The spot beam may be an “earth fixed beam” which illuminates a geographic area on a surface of the earth for a pre-defined period of time. Alternatively, the spot beam may be an “earth moving beam” which illuminates a constantly changing geographic area on the surface of the earth. In this case, the communications device 306 may determine to switch from being served by the NTN aerial vehicle 310 to being served by the other NTN aerial vehicle based on decision criteria.

In FIG. 4, the ground station 330 is connected to the communications circuitry 334 by means of a wireless communications link 312. The communications circuitry 334 receives signals representing downlink data transmitted by the radio network part 301 on the wireless communications link 312 and transmits signals representing the downlink data via the wireless communications link 314 providing a wireless access interface for the communications device 306. Similarly, the communications circuitry 334 receives signals representing uplink data transmitted by the communications device 306 via the wireless communications link 314 and transmits signals representing the uplink data to the ground station 330 on the wireless communications link 312. The wireless communications links 312, 314 may operate at a same frequency, or may operate at different frequencies.

The extent to which the communications circuitry 334 processes the received signals depends on the processing capability of the communications circuitry 334 as explained in more detail with reference to FIGS. 5 and 6 below.

FIG. 5 illustrates an example of an NTN architecture based on the NTN aerial vehicle 310 operating in a transparent manner, meaning that a signal received from the communications device 306 at the NTN aerial vehicle 310 is forwarded (to the communications device 306, to a ground station 330 on Earth or to another NTN aerial vehicle) with only frequency conversion and/or amplification. In such implementations, a wireless access interface (such as an NR Uu interface) connecting the communications device 306 and the base station 332 located on the Earth is provided by the base station 332. In such implementations, the base station 332 may be regarded as “NTN infrastructure equipment”.

FIG. 6 illustrates an example of an NTN architecture where the communications circuitry 332 of the NTN aerial vehicle 310 implements at least some base station functionality. In such cases, the communications circuitry 334 is an example of “NTN infrastructure equipment”. The communications circuitry 334 generates the wireless access interface (such as an NR Uu interface) which connects the NTN aerial vehicle 310 and the communications device 306. For example, the communications circuitry 334 may decode a received signal, and encode and generate a transmitted signal. In other words, the communications circuitry 334 may include some or all of the functionality of a base station (such as a gNodeB or eNodeB). In some examples, latency-sensitive functionality (such as acknowledging a receipt of the uplink data, or responding to a RACH request) may be performed by the communications circuitry 334 partially implementing some of the functions of a base station. A wireless communications feeder link between the NTN aerial vehicle 310 and the ground station 330 may provide connectivity between the communications circuitry 334 and the core network part 302. In scenarios where the NTN aerial vehicle 310 implements at least some base station functionality, the base station 332 located on the Earth may not be present in the NTN 300.

As will be appreciated, the mobility of the coverage area 308 in NTNs can create technical challenges which may not occur in conventional terrestrial networks. For example, where the NTN aerial vehicle 310 is an LEO satellite, the NTN aerial vehicle 310 may complete an orbit of the Earth in around 90 minutes. In this case coverage area 308 generated by the NTN aerial vehicle 310 moves very rapidly with respect to a fixed observation point on the surface of the Earth (for example, an LEO may move at 7.56 km/s). Furthermore, if the number of NTN aerial vehicles 310 in a satellite constellation is sparse, it may be difficult to keep the communications device 306 in a coverage area of the NTN 300. Accordingly, communications devices in NTNs may experience coverage gaps more often than in terrestrial networks. Therefore, the application of technologies developed for terrestrial networks to NTNs (such as small data transmissions) creates technical challenges.

### Small Data Transmissions (SDTs)

3GPP has completed the basic version of 5G in Release 15 of the 3GPP standards, known as the New Radio Access Technology (NR). In addition, enhancements have been made in Release 16 of the 3GPP standards, incorporating new features such as the 2-step RACH procedure [3], Industrial Internet of Things (IIoT) [4] and NR-based Access to Unlicensed Spectrum (NR-U) [5].

Further enhancements have been agreed for Release 17 of the 3GPP standards. For example, small data transmissions (SDT) in the uplink while a transmitting UE is in the RRC_INACTIVE state as well as Multicast and Broadcast Services (MBS) and positioning enhancements have been agreed. With reference to [6], some specific examples of mobile originated small data transmission (MO SDT) and infrequent data traffic may include the following use cases:
Smartphone applications:
Traffic from Instant Messaging services;
Heart-beat/keep-alive traffic from IM/email clients and other applications; and
Push notifications from various applications;
Non-smartphone applications:
Traffic from wearable devices (e.g. periodic positioning information);
Sensors (e.g., Industrial Wireless Sensor Networks transmitting temperature or pressure readings, periodically or in an event-triggered manner); and
Smart meters and smart meter networks sending periodic meter readings.

In addition, based on [6] as mentioned above, uplink small data transmissions have been enabled for UEs in the RRC_INACTIVE state (i.e. without the UE moving to a fully connected state with the network) in order to reduce the signalling overheads as well as power consumption at the UE, and primarily being for infrequent data traffic. SDT on the uplink for UEs in the RRC_INACTIVE state has been agreed for both RACH based schemes (i.e. 2-step and 4-step RACH)—known as Random Access SDT (RA-SDT)—and configured grant (CG) based schemes (CG-SDT), each of which is discussed in greater detail below. This includes general procedures to enable user plane data transmissions for small data packets on the uplink in the inactive state (for example using either message A of the 2-step RACH procedure or message 3 of the 4-step RACH procedure), and enables flexible payload sizes larger than the Release 16 Common Control Channel (CCCH) message size that is possible currently for a UE in the RRC_INACTIVE state to transmit small data in message A or message 3 to support user plane data transmission in the uplink.

It is expected in future releases of the 3GPP standards that SDT will be supported in NTNs. However, as will be explained in more detail below, the prevalence of coverage gaps in NTNs creates technical challenges in supporting SDT efficiently both in terms of signaling costs and UE power consumption.

As described above, three schemes have been agreed by 3GPP for the initiation of SDT on the uplink, originating from a mobile UE in the inactive state. These are:
4-step RACH based scheme;
2-step RACH based scheme; and
CG based scheme.

### 4-Step RACH Scheme

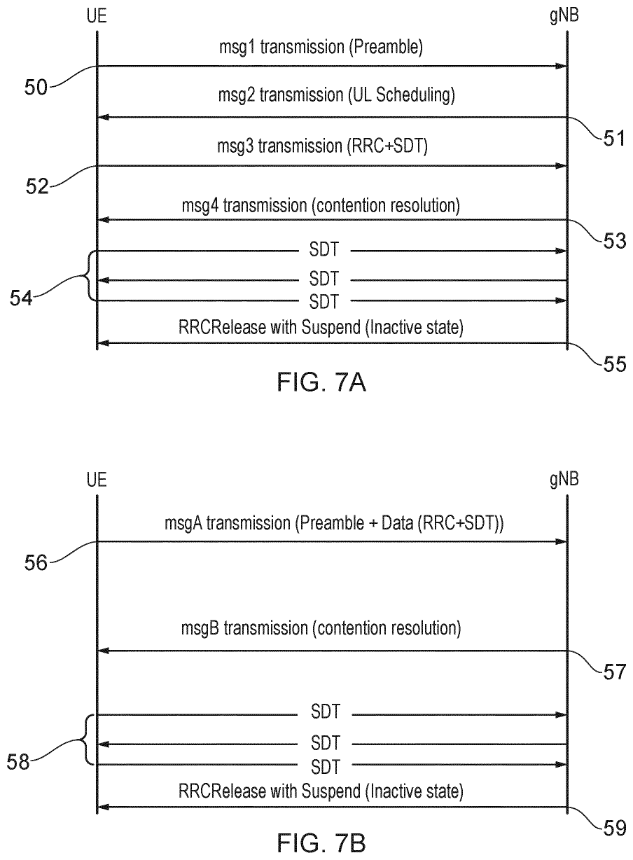

FIG. 7A shows an example of the 4-step RACH based scheme, and shows how MO SDTs can be initiated by such a scheme. When a UE has an UL SDT ready for transmission, it may start a 4-step RACH procedure as shown in FIG. 7A, which comprises the following steps:
A UE starts message 1 transmission 50 of a Physical Random Access (PRACH) preamble from a set of preambles allocated for SDT in the current cell. When a gNB receives the preambles, it identifies this as an SDT initiation, and responds with message 2.
The gNB transmits 51 message 2, which contains UL timing alignment command and UL PUSCH scheduling for message 3.
The UE transmits 52 message 3, which contains Radio Resource Control (RRC) signaling. For example, the UE may transmit an RRC Resume Request. If there is any remaining space in message 3, the UE may also transmit SDT data in message 3. As will be explained in more detail below, the transmission of message 3 may trigger an SDT failure timer at the UE defining a period for which the UE can communicate SDTs with the gNB.
Similarly to the general 4-step RACH procedure, the gNB then provides 53 the contention resolution after the UE that transmitted the preamble in the first step 50 is identified and confirmed. In this step 53, DL and UL feedback or acknowledgments are transmitted.
For UL feedback received by a gNB from a UE in response to transmitting a DL PDSCH to that UE, a HARQ-ACK is transmitted on a cell-specific PUCCH resource configured within the system information (though it should be noted that, that from the third step 52, the UE is already UL-synchronised).
For DL feedback received by a UE in response to transmitting the UL message 3 in the third step 52, the reception of message 4 in the fourth step 53 at the UE is considered as a positive acknowledgment.
After the fourth step 53, the UE is now already identified by the network and is also UL-synchronised. Hence, subsequent UL and DL SDT with dynamic scheduling can take place 54 as required while the UE remains in the INACTIVE state. Once SDT is completed, and neither the gNB or UE have any further small data to transmit, the gNB can choose to keep the UE in RRC_INACTIVE state by sending RRCRelease with suspend indication 55.

### 2-Step RACH Scheme

FIG. 7B shows an example of the 2-step RACH based scheme, and shows how MO SDTs can be initiated by such a scheme. When a UE has an UL SDT ready for transmission, it may start a 2-step RACH procedure as shown in FIG. 7B, which comprises the following steps:
A UE starts message A transmission 56 of a PRACH preamble and associated PUSCH for SDT in the current cell. The PUSCH contains RRC signaling. For example, message (i.e. RRCResumeRequest. If there is any remaining space in the PUSCH, the UE may transmit SDT data. As will be explained in more detail below, the transmission of message A may trigger an SDT failure timer at the UE defining a period for which the UE can communicate SDTs with the gNB.
When the gNB receives 56 message A, it responds 57 with message B which contains both an UL timing alignment command and the contention resolution where the UE which transmitted 56 message A in the first step is identified and confirmed. In this step 57, DL and UL feedback or acknowledgments are transmitted.
For UL feedback received by a gNB from a UE in response to a DL PDSCH being transmitted by the gNB to that UE, a HARQ-ACK is transmitted by the UE on a cell-specific PUCCH resource configured within the system information.
For DL feedback received by a UE from the gNB in response to message A being transmitted 56 by that UE, the reception 57 of message B at the UE is considered as a positive acknowledgment; and
After the second step 57, the UE is now already identified by the network and is also UL-synchronised. Hence, subsequent UL and DL SDT with dynamic scheduling can take place 54 as required while the UE remains in the RRC_INACTIVE state. Once SDT is completed, and neither the gNB or UE have any further small data to transmit, the gNB can choose to keep the UE in RRC_INACTIVE state by sending RRCRelease with suspend indication 59.

### Configured Grant (CG) Scheme

When a UE remains in the same coverage area or cell for a period of time, it is possible that the UE can use some pre-configured UL resources for transmitting data, provided that the UE is UL synchronised, while remaining in the RRC_INACTIVE state. Hence in Release 17 of the 3GPP standards, it has been agreed that a network can configure dedicated CG PUSCH resource(s) for SDT on a dedicated BWP or initial BWP, just before a UE moves to the RRC_INACTIVE state.

The first message of CG contains RRC signalling. For example, the first message of CG may include an RRCResumeRequest. If there is remaining space in the first message of CG, the UE may include SDT data in the first message of CG. As will be explained in more detail below, the first message of CG may trigger an SDT failure timer at the UE defining a period for which the UE can communicate SDTs with the gNB.

### Small Data Transmission (SDT) Failure Timer

As mentioned above, the transmission of message A or message 3 may trigger the commencement of an SDT failure timer at the UE. In some cases, the SDT failure timer may be triggered by the transmission of the first uplink transmission which can deliver SDT data. In such cases, the transmission of message A or message 3 may trigger the SDT failure timer even if those messages do not actually include any SDT data because, for example, there is insufficient space in the message for the SDT data. In some cases, the SDT failure timer may be triggered by the first actual transmission of SDT data. In such cases, the first SDT transmission in step 54 or step 58 may trigger the SDT failure timer. In such cases, if message A or message 3 actually contain SDT data, then those messages would trigger the SDT failure timer. The message which triggers the SDT failure timer may be referred to as an “SDT initiation signal”. The message A may comprise at least a RRCResumeRequest or RRCResumeRequest1 when the resume procedure is initiated for SDT. Alternatively, the message 3 may comprise at least a RRCResumeRequest or RRCResumeRequest1 when the resume procedure is initiated for SDT.

If the UE does not receive any grant scheduling (for example, either DL PDSCH or UL PUSCH) from the gNB before the SDT failure timer expires, the UE may assume that SDT has failed. In some cases, the UE may transition to an idle state (such as the RRC_IDLE state) on expiry of the SDT failure timer. In other words, the SDT failure timer sets a time period during which the UE can communicate SDTs with the gNB.

The time for which the UE can communicate SDTs with the gNB may also be referred to as an “SDT Session”.

In the examples shown in FIGS. 7A and 7B, the RRCRelease with Suspend Message 58, 59 is transmitted from the gNB to the UE before the expiry of the SDT failure timer so as to prevent the UE from transitioning to the RRC_IDLE state by instructing the UE to remain in the RRC_INACTIVE STATE.

There are two options (Opt 1 and Opt 2) under discussion for the implementation of the SDT failure timer:

### Opt 1

The SDT failure timer is started at the beginning of the SDT session (i.e. when the SDT failure timer starts) and is restarted at every subsequent uplink SDT transmission or downlink SDT reception at the UE. For example, with reference to FIG. 7A, the transmission of message 3 may trigger the SDT failure timer. The transmission of the first SDT message in step 54 causes the SDT failure timer to restart. The reception of the second SDT message in step 54 causes the SDT failure timer to restart and the transmission of the third SDT message in step 54 causes the SDT failure timer to restart.

### Opt 2

The SDT failure timer is started at the beginning of the SDT session only. For example, with reference to FIGS. 7A and 7B, the SDT failure timer is started only on transmission of message 3 or message A and is not subsequently restarted.

It will be appreciated that a duration of the time period set by the SDT failure timer will typically be longer for Opt 2 than for Opt 1.

### Small Data Transmission (SDT) for NTN

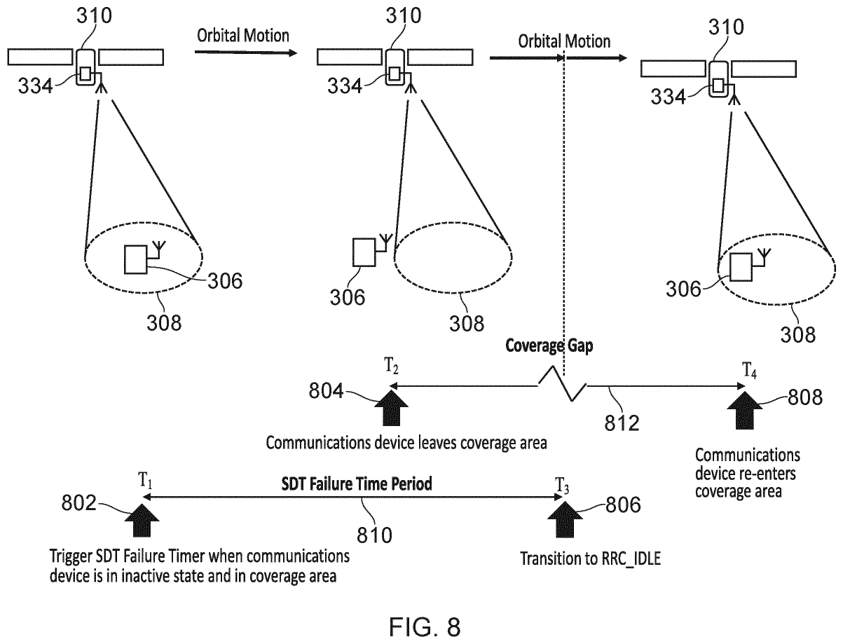

As mentioned above, SDT is expected to be supported for NTN in future releases. However, as will be explained with reference to FIG. 8 below, the prevalence of coverage gaps in NTNs may create technical challenges in the implementation of SDT for NTNs.

FIG. 8 schematically illustrates an orbit of an NTN aerial vehicle which provides a coverage area for a communications device which is in an inactive state (such as an RRC_INACTIVE state). As shown in FIG. 8, at time T₁, the NTN aerial vehicle 310 provides a coverage area 308 for the communications device 306. As explained previously, the coverage area 308 may be provided by a spot beam generated by the communications circuitry 334 of the NTN aerial vehicle 310. The ground station 330, base station 332 and core network 302 described with reference to FIG. 4 may be present but are not shown in FIG. 8 for clarity.

As represented by arrow 802, the communications device 306 commences an SDT failure timer at time T₁ when the communications device is in the coverage area 308 provided by the NTN aerial vehicle 310. The SDT failure timer may be an SDT failure timer according to “Opt 1” or “Opt 2” as discussed above. In any case, the SDT failure timer sets a time period 810 (which may also be referred to as an “SDT Failure Time Period 810”) during which the communications device 306 can communicate SDTs with the NTN aerial vehicle 310. The SDT failure time period 810 is defined mathematically in FIG. 8 as T₃-T₁, where T₃ is the time at which the SDT failure timer expires.

As represented by arrow 804, the communications device 306 leaves the coverage area 308 provided by the NTN aerial vehicle 310 at time T₂ as a result of the orbital motion of the NTN aerial vehicle 310 about the Earth. In the example shown in FIG. 8, the NTN aerial vehicle 310 subsequently continues its orbit about the Earth. The time T₂ is the time at which the communications device 306 leaves the coverage area 308 and may therefore be referred to as the “leaving time”.

As represented by arrow 808, the communications device 306 subsequently re-enters the coverage area 308 provided by the NTN aerial vehicle 310 at time T₄. For example, the communications device 306 may re-enter the coverage area 308 provided by the NTN aerial vehicle 310 after the NTN aerial vehicle 310 has completed its orbit about the Earth. Accordingly, the communications device 306 is located outside the coverage area 308 for a time period of T₄−T₂ which may be referred to as a “coverage gap 812”. The time T₄ is the time at which the communications device 306 re-enters the coverage area 802 after the coverage gap 812 and may therefore be referred to as the “re-entry time”.

Typically, the coverage gap 812 is much longer than the SDT failure time period 810. As a result, as represented by arrow 806 in FIG. 8, the SDT failure timer expires at a time T₃ during the coverage gap 812 and the communications device 306 transitions from the inactive state to an idle state (for example, the RRC_IDLE state).

In some cases, the communications device 306 may not have completed its SDT transmissions before the time T₂ at which the communications device 306 leaves the coverage area 308. In other words, the SDT session has not completed before the communications device 306 leaves the coverage area 308. Therefore, if the communications device 306 has more SDT data to transmit to the NTN aerial vehicle 310, the communications device must re-initiate an SDT session with the NTN aerial vehicle 310 (for example, according to the 4-Step RACH, 2-step RACH, or CG schemes explained above) when the communications device 306 re-enters the coverage area 308 at time T₄.

Although FIG. 8 illustrates an example in which the communications device 306 moves in and out of the same coverage area 308 of the NTN aerial vehicle 310, one or more other NTN aerial vehicles (not shown) in the NTN may also provide one or more coverage areas for the communications device. Accordingly, the communications device 306 can be kept in a coverage area provided by the NTN for a longer period of time than if only one NTN aerial vehicle 310 provided a coverage area for the communications device 306. Despite this, the number of NTN aerial vehicles in an NTN is typically kept low to save costs as a low number of NTN aerial vehicles can provide adequate coverage for many IoT services which only require small, infrequent data transmission. Accordingly, even when multiple NTN aerial vehicle provide coverage for the communications device 306, the communications device 306 will still likely experience coverage gaps.

It will be appreciated that the presence of coverage gaps in NTN networks may create scenarios in which SDT fails frequently. The increased signalling required to re-establish SDT sessions when the communications device 306 is back in the coverage area 308 may lead to increased power consumption in the communications device 306.

### Small Data Transmission (SDT) Failure Timer Adjustment

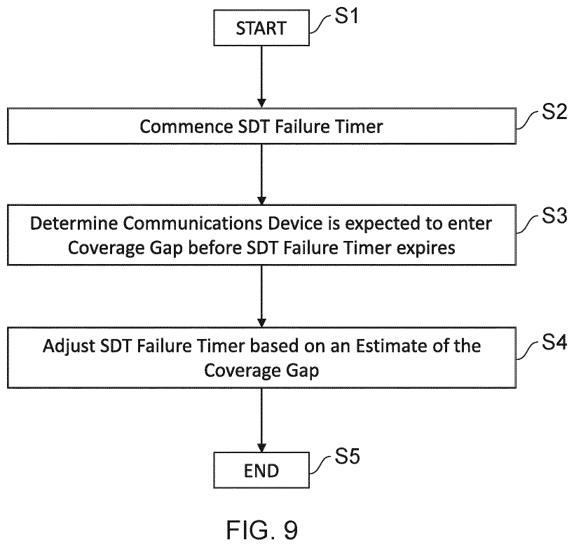

In view of the above, there is provided a method of operating a communications device (such as communications device 306) for transmitting signals to and/or receiving signals from a non-terrestrial network, NTN, while the communications device is in an inactive state (such as an RRC_INACTIVE state). The method is shown in FIG. 9.

The method beings at step S1. After step S1, in step S2, the communications device commences a small data transmission, SDT, failure timer setting a time period (such as the SDT failure time period 810) during which the communications device can communicate one or more SDTs with the NTN when the communications device is located inside a coverage area provided by the NTN (such as coverage area 308). The time period set by the SDT failure timer may alternatively be referred to as an SDT session. The commencement of the SDT failure timer may be triggered by the transmission of an SDT initiation signal as explained above. In some embodiments, the communications device may transition to an idle state if the SDT failure timer expires.

In step S3, the communications device determines that it is expected to enter a coverage gap (such as coverage gap 812) before the SDT failure timer expires. The coverage gap is a time period during which the communications device is located outside the coverage area provided by the NTN. The coverage area provided by the NTN may be a coverage area provided by a single NTN aerial vehicle in the NTN. In this case, the coverage gap is referring to a time period during which the communications device is not in the coverage area provided by the single NTN aerial vehicle. Alternatively, the coverage area provided by the NTN may be referring to a collective coverage area comprising a plurality of coverage areas each provided by a respective one of a plurality of NTN aerial vehicles in the NTN. In this case, the coverage gap is referring to a time period during which the communications device is not in any of the plurality of coverage areas provided by the plurality of NTN aerial vehicles.

The communications device may determine that it is expected to enter the coverage gap based on ephemeris information received from the NTN. Specifically, the ephemeris information may include information regarding an orbit of the one or more NTN aerial vehicles in the NTN each of which provide a coverage area for the communications device. Alternatively, the communications device may receive an indication from the NTN that it is expected to enter the coverage gap before the SDT failure timer expires.

In step S4, the communications device adjusts the commenced SDT failure timer based on an estimate of the coverage gap. For example, the communications device may extend or pause the SDT failure timer based on the estimate of the coverage gap. The communications device may estimate the coverage gap itself based on ephemeris information received from the NTN. Alternatively, the NTN may estimate the coverage gap and transmit an indication of the estimated coverage gap to the communications device. In some embodiments, the NTN may adjust an SDT failure timer maintained at the NTN based on the estimated coverage gap and transmit an indication of the adjusted SDT failure timer to the communications device. In such embodiments, the communications device may adjust the commenced SDT failure timer based on the indication of the adjusted SDT failure timer received from the NTN. In some embodiments the communications device may transmit assistance information to the NTN for assisting the NTN in communicating one or more SDTs with the communications device after the coverage gap. The assistance information may transmitted by the communications device before, during or after the coverage gap. As will be explained in more detail below, the assistance information may include one or more of an estimate of the coverage gap calculated by the communications device, a location of the communications device, a sounding reference signal, and a reserved preamble. In embodiments where the NTN estimates the coverage gap or adjusts the SDT failure timer maintained at the NTN, the communications device may transmit its location to the NTN to enable the NTN to estimate the coverage gap.

Therefore, example embodiments can provide a communications device which can adjust an SDT failure timer so as to prevent the SDT failure timer from expiring during a coverage gap. Accordingly, if a communications device still has SDT data to transmit when it enters a coverage gap, the communications device can finish transmitting its remaining SDT data when it re-enters the coverage area provided by the NTN, thereby avoiding the need to re-establish an SDT session. Consequently, because additional signalling is not required to re-establish the SDT session, communications efficiency is increased the power consumption of the communications device is reduced.

References to NTN should be understood as including one or more NTN aerial vehicles (such as NTN aerial vehicle 310), and a terrestrial radio network part (such as radio network part 301) which may be connected to a core network (such as core network 302). The radio network part 301 may include a ground station (such as ground station 330). In cases where the one or more NTN aerial vehicles operate in a transparent manner according to FIG. 5, the NTN may include a terrestrial base station (such as base station 332) which connects the ground station 330 and the core network 301. In such cases, the terrestrial base station may be regarded as NTN infrastructure equipment. In cases where the one or more NTN aerial vehicles implement at least some base station functionality in accordance with FIG. 6, the terrestrial base station may not be present 332. In such cases, the one or more NTN aerial vehicles may be regarded as NTN infrastructure equipment. Accordingly, references to steps being performed by an NTN may be alternatively be referred to as steps performed by an NTN infrastructure equipment, whether this is the one or more NTN aerial vehicles implementing base station functionality or the terrestrial base station. In cases where the terrestrial base station is the NTN infrastructure equipment, communications between the communications device and the NTN should be understood as meaning communications between the communications device and the one or more NTN aerial vehicles which relay the signals to and from the terrestrial base station. References to a coverage area provided by the NTN should be understood as a coverage area provided by any or all of the one or more NTN aerial vehicles as explained above.

### Estimating the Coverage Gap

As explained above with reference to step S3 of FIG. 9, the communications device 306 is configured to determine that it is expected to enter a coverage gap before the SDT failure timer expires.

It will be appreciated by one skilled in the art that the communications device 306 (which may be a UE) can be made aware of ephemeris information regarding an orbit of one or more NTN aerial vehicles in an NTN (see [7]). For example, the communications device 306 may receive ephemeris information of one or more NTN aerial vehicles from the NTN. In some embodiments, the communications device 306 may receive the ephemeris information of the one or more NTN aerial vehicles from the respective one or more NTN aerial vehicles. The ephemeris information of each NTN aerial vehicle includes information regarding an orbit of the respective NTN aerial vehicle. For example, the ephemeris information may include information indicating a speed, trajectory, orbital radius or the like of the NTN aerial vehicle. In some embodiments, the communications device may be aware of the ephemeris information even before entering the inactive state.

The communications device 306 may be configured to predict a path of the one or more NTN aerial vehicles based on the ephemeris information. Accordingly, the communications device 310 may be configured to determine that the communications device 310 is expected to enter the coverage gap before the SDT failure timer expires based on the ephemeris information. In some embodiments, the communications device 306 may also be configured to estimate the coverage gap based on the ephemeris information. For example, the communications device 306 may estimate a leaving time (for example, T₂) at which the communications device 306 is expected to leave the coverage area 308 provided by the NTN based on the ephemeris information. The communications device 306 may additionally estimate at re-entry time (for example, T₄) at which the communications device 306 is expected to re-enter the coverage area 306 based on the ephemeris information. The communications device 306 may determine a time (for example, T₃) at which the SDT failure timer expires. The communications device 306 may determine that the time T₃ occurs during the coverage gap 308 defined by T₄−T₂. The estimation of the coverage gap may additionally be based on a location of the communications device 306 which may be known to the communications device 306 from GPS for example.

Alternatively, the NTN may determine that the communications device is expected to enter the coverage gap 812 before the SDT failure timer expires based on the ephemeris information of one or more NTN aerial vehicles. The NTN may transmit the indication to the communications device 306 that the communications device 306 is expected to enter the coverage gap before the SDT failure timer expires. The indication received from the NTN may be a signal which explicitly informs the communications device 306 that the communications device 306 is expected to enter the coverage gap 308 before the SDT failure timer expires, or the indication may implicitly inform the communications device 306 that the communications device 306 is expected to enter the coverage gap 308 before the SDT failure timer expires. An example of an implicit indication is where the NTN determines the leaving time (for example, T₂) at which the communications device 306 is expected to enter the coverage gap and the leaving time (for example, T₄) based on ephemeris information held at the NTN. The NTN transmits the leaving time and the re-entry time to the communications device 306 and the communications device 306 uses the leaving time to determine that it is expected to enter the coverage gap 308 before the SDT failure timer expires. Another example of the implicit indication is where the NTN estimates the coverage gap 308 and transmits and indication of the estimated coverage gap to the communications device 306. For example some embodiments, the NTN may estimate the coverage gap 812 based on the ephemeris information of the one or more NTN aerial vehicles and transmit an indication of the estimated coverage gap 812 to the communications device 306. The estimation of the coverage gap may additionally be based on a location of the communications device 306 which may be received by the NTN from the communications device 306.

The steps performed by the NTN may be performed by one or more NTN aerial vehicles or may be performed by a base station of the NTN (such as base station 332). For example, an NTN aerial vehicle (such as NTN aerial vehicle 310) which provides the coverage area 308 for the communications device may determine that the communications device is expected to enter the coverage gap 812 and transmit a signal to the communications device indicating that it is expected to enter the coverage gap 812. However, in embodiments where the NTN aerial vehicle 310 operates in a transparent manner according to FIG. 5, the determination may be performed by a terrestrial base station connected to the NTN aerial vehicle (such as base station 332) and the indication of the determination is transmitted by the base station to the communications device 306 via the NTN aerial vehicle 310.

In some embodiments, such as that shown in FIG. 8, the coverage gap (for example, coverage gap 812) is a time period for which the communications device 306 is outside the coverage area 308 of the same NTN aerial vehicle (for example NTN aerial vehicle 310). In such embodiments, since the communications device 306 does not need to connect to a new cell or coverage area, the communications device 306 does not need to perform cell reselection, an uplink synchronisation procedure or a Random Access Channel (RACH) procedure. In other words, the communications device 306 halts SDT transmission and/or reception when the communications device 306 is outside the coverage area 308 and continues SDT transmission and/or reception when the communications device 306 re-enters the coverage area 308.

In other embodiments, where there is a plurality of NTN aerial vehicles in an NTN, each of the NTN aerial vehicles may provide a respective coverage area for the communications device 306. In such embodiments, the coverage gap may be a time period for which the communications device is not in any of the coverage areas provided by the plurality of NTN aerial vehicles. For example, if the communications device 306 is in a first coverage area provided by a first NTN aerial vehicle for a first period of time, and the communications device 306 is in a second coverage area provided by a second NTN aerial vehicle for a second period of time, then the coverage gap may be the time between the expiry of the first period and the start of the second period. In such embodiments, the first and second NTN aerial vehicles may be connected to the same base station (such as base station 332). In such embodiments, the communications device 306 may use ephemeris information received from the second NTN aerial vehicle to search, perform measurement and cell selection/reselection for the second coverage area provided by the second NTN aerial vehicle.

In some embodiments, the estimate of the coverage gap is based on a location of the communications device 306, elevation angle, and satellite beam information as well as the ephemeris information. The communications device 306 and one or more of the NTN aerial vehicles may be synchronised to a common timing source, for example, Global Positioning System, an atomic clock or other timing source as will be appreciated by one skilled in the art.

### Extending the SDT Failure Timer

In some embodiments, the communications device 306 is configured to extend the SDT failure timer based on the estimate of the coverage gap 812. For example, with reference to FIG. 8, the communications device 306 may determine that it is expected to enter the coverage gap 812 before the expiry of the SDT failure timer. In other words, the communications device 306 may determine that it is expected to enter the coverage gap 812 before the end of the SDT session. The communications device 308 may determine an estimate of the coverage gap 812 (either by estimating the coverage gap itself or by receiving an indication of an estimated coverage gap 812 from the NTN as explained above). The communications device 306 may then extend the SDT failure timer by an amount corresponding to the estimated coverage gap 812. For example, the SDT failure timer may be increased by an amount approximately equal to the estimated coverage gap 812. In other examples, the SDT failure timer may be increased by an amount greater than the coverage gap 812.

In some embodiments, after extending the SDT failure timer, the communications device 306 may enter a sleeping state for the period defined by the coverage gap 812. The sleeping state may be a light sleep or micro sleep (for example, see [8]) so that the communications device 306 can maintain a timer while in the sleeping state. In other words, the communications device can monitor the extended SDT failure timer while in the sleeping state. The communications device 306 may exit the sleeping state when it determines that it has re-entered the coverage area 308. Accordingly, the communications device 306 can save power when in the coverage gap 812.

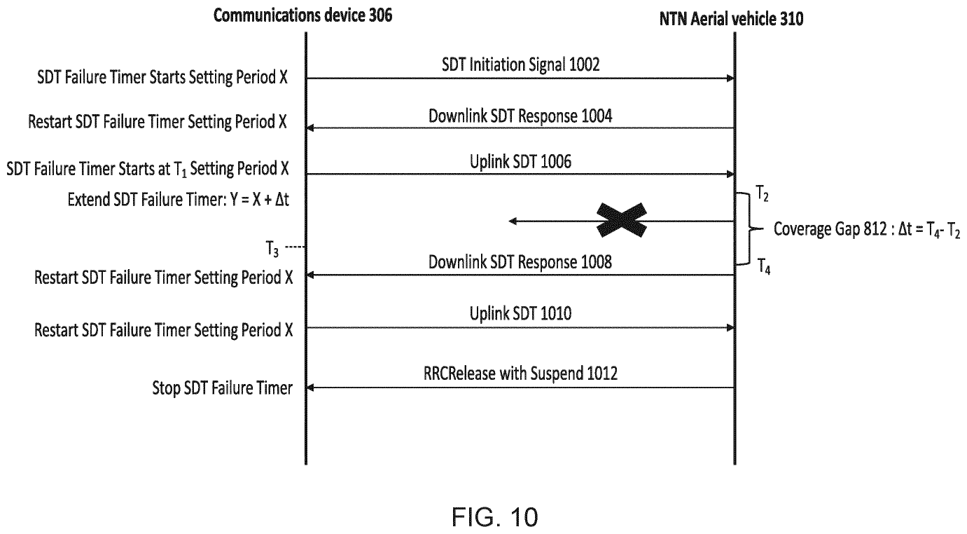

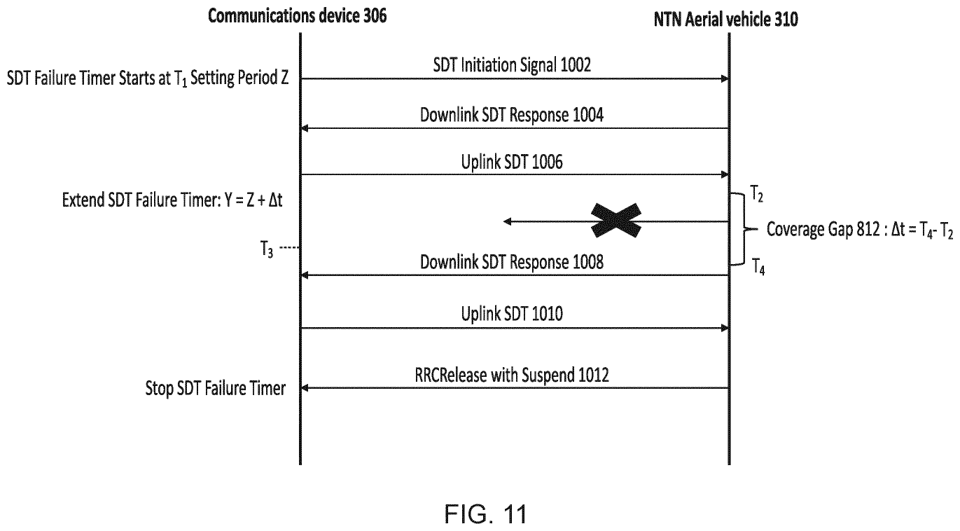

Embodiments in which the SDT timer is extended based on the estimate of the coverage gap are explained below with reference to FIGS. 10 and 11.

FIG. 10 schematically illustrates the communications device 306 extending the SDT failure timer when the SDT failure timer operates in accordance with Opt1 as explained above. The communications device 306 transmits an SDT initiation signal 1002 to the NTN aerial vehicle 310. The SDT initiation signal 1002 may be message A or message 3 in some embodiments. In some embodiments, the SDT initiation signal 1002 may be a PUSCH. As explained previously, where the SDT initiation signal 1002 is message 3 or message A, it may or may not include SDT data. As mentioned above, message A may comprise at least an RRCResumeRequest or RRCResumeRequest1. Alternatively, message 3 may comprise at least an RRCResumeRequest or RRCResumeRequest1.

In response to transmitting the SDT initiation signal 1002, the communications device 306 commences an SDT failure timer according to Opt1. The SDT failure timer sets a time period X during which the communications device 306 can communicate one or more SDTs the with the NTN aerial vehicle 310. The time period X may be referred to as the SDT failure time period. Before the SDT failure timer expires, the communications device 306 receives a first downlink SDT response 1004 from the NTN aerial vehicle 310. The first downlink SDT response 1004 may schedule uplink or downlink SDT transmissions. In such cases, the first downlink SDT response 1004 include a PDCCH. In some cases, the first downlink SDT response 1004 may include SDT data. In such cases, the first downlink SDT response 1004 may include a PDSCH. In response to receiving the first downlink SDT response 1004, the communications device 306 restarts the SDT failure timer which resets the time period X during which the communications device 306 can communicate one or more SDTs with the NTN aerial vehicle 310.

Before the SDT failure timer expires, the communications device 306 transmits an uplink SDT 1006 to the NTN aerial vehicle 310. The uplink SDT 1006 may include a PUSCH and/or a PUCCH. In response to transmitting the uplink SDT, the communications device 306 restarts the SDT failure timer which resets the time period X. In one example, the transmission of the uplink SDT 1006 may occur at time Ti as shown FIG. 8 and FIG. 10. In this example, X=T₃−T₁.

Before the SDT failure timer expires, the communications device 306 determines that the communications device 306 is expected to enter the coverage gap 812 before the expiry of the SDT failure timer. In one example, coverage gap 812 may occur between time T₂ and time T₄ as shown in FIG. 8 and FIG. 10. In this example, the coverage gap 812 may be represented by: Δt=T₄−T₂. The communications device 306 may calculate At by estimating T₂ and T₄ from ephemeris information received from the NTN aerial vehicle 310. Alternatively, the NTN aerial vehicle 310 may calculate Δt by estimating T₂ and T₄ based on the ephemeris information which is known to the NTN aerial vehicle 310. The estimation of T₄ and T₂ may be additionally based on a location of the communications device 306 which may be known to the communications device 306 and transmitted from the communications device 306 to the NTN aerial vehicle 310 received from the communications device 306.

As will be appreciated from FIG. 10, if the SDT failure timer which is restarted at time T₁ is not adjusted, the SDT failure timer will expire at time T₃ which occurs during the coverage gap 812. In such cases, the communications device 306 may transition to an idle state (for example, an RRC_IDLE state) which means the communications device 306 can no longer communicate SDTs with the NTN aerial vehicle 310 without incurring increased signalling and power consumption as explained above.

In accordance with example embodiments, the communications device 306 extends the SDT failure timer by an estimate of the coverage gap 812. For example, as shown in FIG. 10, the communications device 306 extends the SDT failure timer by adding the coverage gap 812 to the SDT failure time period X set at time T₁. In some embodiments, the SDT failure timer is extended by adding the coverage gap 812 to the remaining time on the SDT failure timer when the SDT failure timer is extended. For example, the SDT 50 failure timer may be extended by adding the coverage gap 812 to the SDT failure time period X set at time T₁ less the time between the first uplink SDT 1006 and the time at which the SDT failure timer is extended.

As explained previously, after the communications device 306 extends the SDT timer, it may enter a sleeping state. Before the expiry of the extended SDT failure timer, the communications device 306 re-enters the coverage area 308 provided by the NTN aerial vehicle 310. The communications device 306 may then awake and exit the sleeping state.

Subsequently, the communications device 306 receives a second downlink SDT response 1008 from the NTN aerial vehicle 310. In response, the communications device 306 restarts the SDT failure timer which resets the SDT failure time period to X. Subsequently, the communications device 306 transmits a second uplink SDT 1010 to the NTN aerial vehicle 310 and restarts the SDT failure timer which resets the SDT failure time period to X. With the transmission of the second uplink SDT 1010, the communications device 306 has completed all intended SDT transmissions and receptions with the NTN aerial vehicle 310. The NTN aerial vehicle 310 may determine that there is no more SDT data to be transmitted in the SDT session based on a Buffer Status Report (BSR) received from the most recent data transmission (for example, PUSCH) received from the communications device 310. For example, second uplink SDT 1010 may be a PUSCH which includes a BSR indicating how much data remains in the buffer of the communications device 306. Alternatively, the NTN aerial vehicle 310 may be aware that there is no more SDT data to be transmitted in the SDT session because the NTN aerial vehicle 310 may, in some examples, be configured to transmit data to the communications device 306 based on a fixed, periodic data rate.

In response, the NTN aerial vehicle 310 transmits, before the expiry of the SDT failure timer, an instruction 1012 to the communications device 306 to remain in the inactive state. The instruction 1012 may be an RRCRelease with suspend indication for example. In response to receiving the instruction, the communications device 306 stops the SDT failure timer.

FIG. 11 schematically illustrates the communications device 306 extending the SDT failure timer when the SDT failure timer operates in accordance with Opt 2 as explained above. FIG. 11 is broadly based on FIG. 10 and so only the differences will be explained for conciseness. In FIG. 11, in response to transmitting the SDT initiation signal 1002, the communications device 306 starts an SDT failure timer setting a period Z during which the communications device can communicate one or more SDTs with the NTN aerial vehicle 310. The time period Z may be referred to as an SDT failure time period. It will be appreciated that the time period Z in Opt 2 is typically larger than the time period X in Opt 1. In FIG. 11, the time at which the communications device 306 transmits the SDT initiation signal 1002 may correspond to time T₁ in FIG. 8. Accordingly, the SDT failure time period Z may be represented by Z=T₃−T₁. In FIG. 11, the SDT timer runs continuously and does not restart when the communications device 306 receives the first downlink SDT response 1004 or transmits the first uplink SDT 1006 for example.

In FIG. 11, after the communications device 306 determines that it will experience the coverage gap 812, the communications device 306 extends the SDT failure timer by an estimate of the coverage gap 812. For example, as shown in FIG. 11, the communications device 306 extends the SDT failure timer by adding the coverage gap 812 to the SDT failure time period Z set at time T₁. In some embodiments, the SDT failure timer is extended by adding the coverage gap 812 to the remaining time on the SDT failure timer when the SDT failure timer is extended. For example, the SDT failure timer may be extended by adding the coverage gap 812 to the SDT failure time period Z set at time T₁ less the time between the SDT initiation signal 1002 and the time at which the SDT failure timer is extended.

Subsequently, the communications device 306 receives the second downlink SDT response 1008, transmits the second uplink SDT 1010 and receives the instruction 1012 to remain in the inactive state as previously explained for FIG. 10. In the case of FIG. 11, the SDT failure timer is not restarted on the transmission of the second downlink SDT response 1008 or the transmission of the second uplink SDT 1010.

Although FIGS. 10 and 11 describe the transmission of two uplink SDTs 1006, 1010 and two downlink SDT responses 1004, 1008, it will be appreciated that fewer or more uplink SDTs or downlink SDT responses could be transmitted.

As explained above, FIGS. 10 and 11 illustrate communications between the communications device 306 and the NTN aerial vehicle 310. In such embodiments, the NTN aerial vehicle is operating as NTN infrastructure equipment. In other embodiments, where the NTN aerial vehicle 310 operates in a transparent manner according to FIG. 5, the communications received by the NTN aerial vehicle 310 from the communications device 306 are forwarded to a terrestrial base station (such as base station 332) for processing, and the communications transmitted by the NTN aerial vehicle to the communications device 306 are relayed to the communications device 306 from the terrestrial base station via the NTN aerial vehicle 310. In some embodiments, where the coverage area is provided by a plurality of NTN aerial vehicles, the plurality of NTN aerial vehicles may each receive and forward the communications shown in FIGS. 10 and 11 between the terrestrial base station (which is connected to each of the plurality of NTN aerial vehicles) and the communications device 306. In embodiments where communications are relayed between the terrestrial base station and the communications device 306 via one or more NTN aerial vehicles, the terrestrial base station is operating as NTN infrastructure equipment. Therefore, although the steps shown in FIGS. 10 and 11 are performed by the NTN aerial vehicle 310 when it is operating as NTN infrastructure equipment, those steps could equally be performed by a terrestrial base station operating as NTN infrastructure equipment.

### Pausing the SDT Failure Timer

In some embodiments, the communications device 306 is configured to pause the SDT failure timer based on an estimate of the coverage gap 812. For example, the communications device 306 may, in response to determining that it is expected to enter the coverage gap 812 before the expiry of the SDT timer, pause the SDT timer for a time period corresponding to the coverage gap 812. For example, the SDT failure timer may be paused for a time period approximately equal to the estimated coverage gap 812. In other examples, the SDT failure timer may be paused for a time period greater than the coverage gap 812. As explained above, the communications device 306 may save power by entering a sleeping state when it is in the coverage gap 812.

### Restarting the SDT Failure Timer

In some embodiments, the communications device 306 is configured to restart the SDT failure timer based on an estimate of the coverage gap 812. For example, the communication device 306 may, in response to determining that it is expected to enter the coverage gap 812 before the expiry of the SDT timer, restart the SDT failure timer. For example, the communications device 306 may determine, based on the estimated coverage gap 812, that if the SDT failure timer is restarted then it will expire after when the communications device 306 re-enters the coverage area 308.

In some embodiments, the communications device 306 may either extend or pause the SDT failure timer as explained above and subsequently re-start the SDT failure timer when the communications device 306 re-enters the coverage area 308 (for example, at time T₄). As explained above, the communications device 306 may save power by entering a sleeping state when it is in the coverage gap 812.

### SDT Adjustment Timer

Embodiments have been discussed above where the communications device 306 adjusts the SDT failure timer by extending, pausing of restarting the SDT timer based on the estimate of the coverage gap 812. In some embodiments, the NTN (for example, the NTN aerial vehicle 310) may determine an “SDT adjustment timer” for the communications device 306. The SDT adjustment timer may be a timer which can be used by the communications device 306 to adjust the SDT failure timer which is maintained at the communications device 306. For example, the NTN aerial vehicle 310 may transmit the SDT adjustment timer to the communications device 306. Then, in response to determining that it is about to enter the coverage gap 812, the communications device 306 pauses the SDT failure timer and starts the SDT adjustment timer. Then, when the SDT adjustment timer expires, the communications device 306 re-starts the SDT failure timer. Alternatively, the communications device 306 may extend the SDT failure timer based on the SDT adjustment timer.

The NTN aerial vehicle 310 may transmit the SDT adjustment timer to the communications device 306 via a Medium Access Control (MAC) Control Element (CE). The SDT adjustment timer may be transmitted 50 before the coverage gap 812 so that the communications device 306 can adjust its SDT failure timer based on the SDT adjustment timer in advance, or at the start of, the coverage gap 812.

The NTN aerial vehicle 310 may determine the duration of the SDT adjustment timer based on the estimated coverage gap 812. For example, the duration of the SDT adjustment timer may be approximately equal to the duration of the coverage gap 812. In some embodiments, the NTN aerial vehicle 310 may set the duration of the SDT adjustment timer longer than the duration of the coverage gap 812 to reduce the likelihood of the SDT failure timer expiring during the coverage gap 812 even further. In some embodiments, after the communications device 306 adjusts the SDT failure timer based on the SDT adjustment timer, the communications device 306 may enter a sleeping state (such as a light or micro sleep as mentioned above). In the sleeping state, the communications device 306 can monitor the adjusted SDT timer which is running while the communications device 306 is in the sleeping state. The communications device 306 may exit the sleeping state when it determines that it has re-entered the coverage area 308. The use of such a sleeping state thereby reduces a power consumption of the communications device 306.

In some embodiments, the SDT adjustment timer may be an SDT failure timer which is maintained at the NTN aerial vehicle 310. For example, the NTN aerial vehicle 310 may adjust an SDT timer maintained at the NTN aerial vehicle 310 based on the estimated coverage gap 812. In such embodiments, the NTN aerial vehicle 310 may transmit an indication of the adjusted SDT failure timer to the communications device 310 and, in response, the communications device 306 replaces its SDT failure timer with the adjusted SDT failure timer received from the NTN aerial vehicle 310.

### Assistance Information

As explained above, in some embodiments such as that shown in FIG. 8, the coverage gap 812 is a time period for which the communications device 306 is outside the coverage area 308 of the same NTN aerial vehicle 310. In such embodiments, since the communications device 306 does not need to connect to a new cell or coverage area, the communications device 306 does not need to perform cell reselection, an uplink synchronisation procedure or a Random Access Channel (RACH) procedure. In other words, the communications device 306 halts SDT transmission and/or reception when the communications device 306 is outside the coverage area 308 and continues SDT transmission and/or reception when the communications device 306 re-enters the coverage area 308.

However, some NTNs may include a large number of communications devices which experience coverage gaps as the one or more NTN aerial vehicles in the NTN follow their orbital trajectory. In such cases, a high burden is placed on an NTN which may be required to store the status of data transmission or reception of each connected or inactive communications device which is communicating with the NTN, even during the coverage gap 308. The NTN may also be required to store the location of the communications devices.

In some embodiments the communications device 306 may transmit assistance information to the NTN aerial vehicle 310 for assisting the NTN aerial vehicle in communicating one or more SDTs with the communications device 306 after the coverage gap 812. The assistance information is transmitted by the communications device 206 either before, during or after the coverage gap 812. As will be explained in more detail below, the assistance information may include one or more of an estimate of the coverage gap 812 calculated by the communications device 306, a location of the communications device 306, a sounding reference signal, and a reserved preamble.

### Location Reporting in Inactive State

In accordance with example embodiments, the communications device 306 may determine its location and report its location to the NTN (for example, to the NTN aerial vehicle 310) while the communications device 306 is in the inactive state (such as the RRC_INACTIVE state). For example, the communications device 306 may determine its location from a plurality of positioning reference signals (PRS) received from 50 the NTN. The PRS signals may be transmitted to the communications device 306 via system information (for example, via positioning system information blocks), via RRCRelease with suspend messages or via downlink SDT data. After determining its location, the communications device 306 may transmit a location report to the NTN via uplink SDT data including an indication of the location of the communications device 306.

In some embodiments, the communications device 306 is configured to determine its location from an Sounding Reference Signal (SRS) configuration. The communications device 306 may receive the SRS configuration via a RRC release with suspend message or via downlink SDT data. Alternatively, the communications device 306 may be pre-configured with the SRS configuration when the communications device 306 was in a connected mode (such as the RRC_CONNECTED mode) or downlink SDT data or pre-configure when the UE was in connected mode.

After receiving the location report of the communications device 306, the NTN aerial vehicle 310 is aware of both its own location and the location of the communications device 306. Consequently, after the coverage gap 812 has ended, the NTN aerial vehicle 310 is configured to reconnect communications devices to finish the SDT session based on its own location and the reported location of the communications device 306. The accuracy of the location of the NTN aerial vehicle 310 may depend on the NTN aerial vehicle 310 speed or reappearance time. The accuracy of the location of the communications device as determined by the NTN aerial vehicle may depend on the speed of the communications device 310 and an accuracy of the reported location of the communications device 306

In some scenarios, the communications device 306 may not be able to report an accurate location of the communications device 306 to the NTN due to User privacy issues (even if the communications device 306 can determine its location accurately). Location reporting in the inactive state has an increased accuracy if the communication device 306 does not move after reporting its location to the NTN.

### Uplink Sounding Reference Signal (SRS) on Configured Resources

In accordance with example embodiments, dedicated uplink SRS resources may be pre-configured for the communications device 306 to inform the NTN aerial vehicle 310 that the communications device 306 is either in, or is expected to be in, the coverage area 308 provided by the NTN aerial vehicle 310. For example, after the communications device 308 has determined that it is expected to enter the coverage area 308 provided by the NTN aerial vehicle 310, the communications device 306 may transmit an uplink SRS to the NTN aerial vehicle 310 on the pre-configured uplink SRS resources dedicated for the communications device 306. The uplink SRS may include an indication that the communications device 306 is either in, or is expected to be in, the coverage area 308 provided by the NTN aerial vehicle 310. The uplink SRS may include an indication that the communications device 306 is either performing, or intends to perform, SDT communications with the NTN aerial vehicle.

Furthermore, the dedicated uplink SRS resources may be pre-configured for a plurality of communications devices each of which use the respective resources to transmit an uplink SRS including an indication of whether the respective communications device is in, or expected to be in, the coverage area 308 provided by the NTN aerial vehicle 310.

In some cases, the NTN may link the presence of the plurality of communications devices from which the uplink SRSs are received. Therefore it may not be necessary for each of the plurality of communications devices to transmit an uplink SRS in order for the NTN to determine that each of the plurality of communications devices are performing SDT. In such embodiments, the communications devices may also report their location to the NTN aerial vehicle 310 while in the inactive state as explained above. For example, the NTN may link the presence of users of communications devices in a region (such as the UK for example) as follows: an NTN aerial vehicle hovers over UK airspace and receives uplink SRS from at least one communications device from the UK. Based on the uplink SRS received from the at least one communications device, the NTN aerial vehicle determines that communications devices from the UK are performing SDT. Therefore, it may not be necessary for the NTN aerial vehicle to receive uplink SRS from any other communications devices in the UK.

Based on the one or more received uplink SRSs, the NTN aerial vehicle 310 can retrieve a context of each of the one or more communications devices, and resume SDT data transmission and reception after the coverage gap 812. The retrieval of the context may be a retrieval of the context of the one or more communications devices from which uplink SRSs were received or one or more communications devices whose presence has been linked as explained above. Following the example above, the retrieval of the context of the communications devices in the UK may be triggered by the NTN aerial vehicle 310 moving into UK airspace and receiving an uplink SRS from at least one communications device in the UK. The NTN aerial vehicle 310 may retrieve the context from a terrestrial base station (such as a gNB). The following architectures are possible:
The NTN aerial vehicle 310 is a transparent bent pipe and almost all “gNB functionality” resides in the terrestrial base station. Retrieving the context of one or more communications devices implies all components of gNB are active/ready for the communications devices In this case, the terrestrial base station is an example of NTN infrastructure equipment,
The NTN aerial vehicle 310 comprises a gNB DU entity and the terrestrial base station comprises a CU entity. The CU entity may store the context of the one or more communications devices and activate/prepare different contexts based on a location of the NTN aerial vehicle 310. In this example, the NTN aerial vehicle and the terrestrial base station may be regarded as NTN infrastructure equipment.
The NTN aerial vehicle 310 is bent pipe and also hosts a UPF function. In such cases, the NTN aerial vehicle 310 may be used for backhauling.

### Transmission on Reserved Preamble

In accordance with example embodiments, a reserved preamble may be pre-configured for the communications device 306 to inform the NTN aerial vehicle 310 that the communications device 306 is either in, or is expected to be in, the coverage area 308 provided by the NTN aerial vehicle 310. For example, after the communications device 308 has determined that it is expected to enter the coverage area 308 provided by the NTN aerial vehicle 310, the communications device 306 may transmit, to the NTN aerial vehicle 310, an indication that the communications device 306 is either in, or is expected to be in, the coverage area 308 provided by the NTN aerial vehicle 310 using the reserved preamble.

When the NTN aerial vehicle 310 receives the indication transmitted by the reserved preamble, the NTN aerial vehicle 310 may retrieve a context for the communications device 306 (as explained above) and resume SDT data transmission and reception after the coverage gap 812.

The reserved preamble is specific to a particular communications device, thereby enabling the NTN to identify the communications device from which the reserved preamble was received. The NTN may allocate a plurality of reserved preambles to a respective plurality of communications devices using RRC signalling for example. The reserved preamble may be transmitted by the communications device 306 at a pre-defined point in time such as, for example, when the NTN aerial vehicle 310 enters a pre-defined region. Following the example given above, the communications device 306 may transmit the reserved preamble to the NTN aerial vehicle 310 when the NTN aerial vehicle 310 enters the UK.

### Timing Alignment

In accordance with example embodiments, the communications device 306 and the NTN aerial vehicle 310 may be synchronised to a reference timing source. Examples of a reference timing source may be a GPS or atomic clock. The reference timing source may have the granularity of URLLC time in one example. The synchronisation to the reference timing source has an increased accuracy if the communication device 306 does not move after synchronisation.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

### NTN Infrastructure Equipment

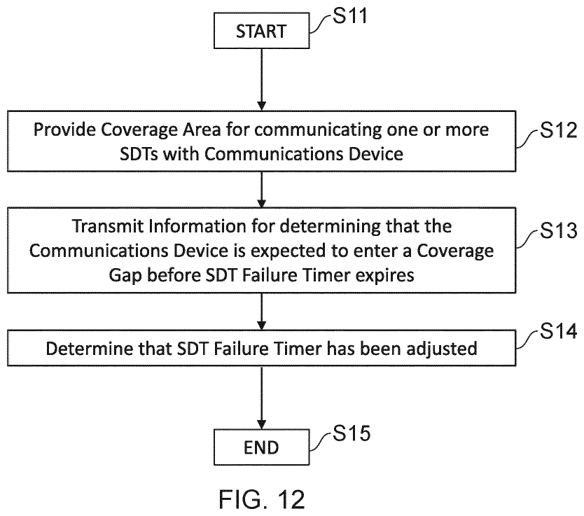

In accordance with example embodiments, there is provided a method of operating a method of operating non-terrestrial network, NTN, infrastructure equipment (such as NTN aerial vehicle 310 or a terrestrial base station such as base station 332) for transmitting signals to and/or receiving signals from a communications device (such as communications device 306) while the communications device is in an inactive state. The method is shown in FIG. 12.

The method starts at step S11. In step S12, the NTN infrastructure equipment provides a coverage area for communicating one or more small data transmissions, SDTs, with the communications device when the communications device is located inside the coverage area (such as coverage area 308). The NTN infrastructure equipment can communicate the one or more SDTs with the communications device during a time period set by an SDT failure timer commenced by the communications device (for example, the SDT failure time period 810).

In step S13, the NTN infrastructure equipment transmits, to the communications device, information for determining that the communications device is expected to enter a coverage gap before the SDT failure timer expires. The information may comprise ephemeris information regarding an orbit of one or more NTN aerial vehicles which provide the coverage area for the communications device for the communications device to estimate the coverage gap. The information may be an indication of a leaving time (for example, T₂) when the communications device is expected to leave the coverage area and a re-entry time (for example, T₄) when the communications device is expected to re-enter the coverage area. In such cases, the leaving time and re-entry time may be determined by the NTN. The information may be an estimate of the coverage gap determined by the NTN. The information may comprise an explicit signal informing the communications device that it is expected to enter the coverage gap before the SDT failure timer expires. The information may comprise an indication of the SDT failure adjustment timer.

In step S14, the NTN infrastructure equipment determines that the SDT failure timer has been adjusted by the communications device. For example, the NTN infrastructure equipment may determine that the communications device has left the coverage area. The NTN infrastructure equipment may also determine that it still has one or more SDTs to communicate with the communications device. For example, the NTN infrastructure equipment may still have SDT data in its buffer to transmit to the communications device or the NTN infrastructure equipment may determine that the communications device still has SDT data in its buffer to transmit to the NTN infrastructure equipment based on a buffer status report received from the communications device. The NTN infrastructure equipment may also determine that the communications device has re-entered the coverage area after the coverage gap. Based on these determinations, the NTN infrastructure equipment may determine that the SDT failure timer has been adjusted by the communications device. This is because, if the SDT failure timer had not been adjusted by the communications device, then the NTN infrastructure equipment would expect to detect that the SDT session has ended (because, for example, the communications device has transitioned from the inactive state to the idle state during the coverage gap). In other words, the NTN infrastructure equipment deduces that the time period set by the SDT failure timer must have been adjusted by the communications device because the NTN infrastructure equipment is able to communicate one or more of the remaining SDTs with the communications device after the coverage gap without detecting that the SDT session has ended. In response to, or as part of, determining that the SDT failure timer has been adjusted by the communications device, the NTN infrastructure equipment may communicate the one or more remaining SDTs with the communications device. The method ends at step S15.

The following numbered paragraphs provide further example aspects and features of the present technique:

Paragraph 1. A method of operating a communications device for transmitting signals to and/or receiving signals from a non-terrestrial network, NTN, while the communications device is in an inactive state, the method comprising,
commencing a small data transmission, SDT, failure timer setting a time period during which the communications device can communicate one or more SDTs with the NTN when the communications device is located inside a coverage area provided by the NTN,
determining that the communications device is expected to enter a coverage gap before the SDT failure timer expires, the coverage gap being a time period during which the communications device is located outside the coverage area provided by the NTN, and
adjusting the commenced SDT failure timer based on an estimate of the coverage gap.

Paragraph 2. A method according to paragraph 1, wherein the adjusting the commenced SDT failure timer based on an estimate of the coverage gap comprises
extending the SDT failure timer based on the estimate of the coverage gap.

Paragraph 3. A method according to paragraph 1 or paragraph 2, wherein the adjusting the commenced SDT failure timer based on an estimate of the coverage gap comprises
pausing the SDT failure timer based on the estimate of the coverage gap.

Paragraph 4. A method according to any of paragraphs 1 to 3, wherein the adjusting the commenced SDT failure timer based on an estimate of the coverage gap comprises
determining that the coverage gap has ended and, in response,
restarting the SDT failure timer.

Paragraph 5. A method according to any of paragraphs 1 to 4, wherein the determining that the communications device is expected to enter a coverage gap before the SDT failure timer expires comprises
receiving, from the NTN, ephemeris information regarding an orbit of one or more NTN aerial vehicles which provide the coverage area for the communications device, and
determining that the communications device is expected to enter the coverage gap before the SDT failure timer expires based on the received ephemeris information.

Paragraph 6. A method according to paragraph 5, wherein the determining that the communications device is expected to enter the coverage gap before the SDT failure timer expires based on the received ephemeris information comprises
estimating the coverage gap based on the received ephemeris information, wherein the adjusting the commenced SDT failure timer based on an estimate of the coverage gap comprises
adjusting the commenced SDT failure timer based on the coverage gap estimated by the communications device based on the received ephemeris information.

Paragraph 7. A method according to any of paragraphs 1 to 5, wherein the determining that the communications device is expected to enter a coverage gap before the SDT failure timer expires comprises
receiving, from the NTN, an indication that the communications device is expected to enter the coverage gap before the SDT failure timer expires.

Paragraph 8. A method according to paragraph 7, wherein the receiving, from the NTN, an indication that the communications device is expected to enter the coverage gap before the SDT failure timer expires comprises
receiving the estimate of the coverage gap from the NTN, wherein the adjusting the commenced SDT failure timer based on an estimate of the coverage gap comprises
adjusting the commenced SDT failure timer based on the coverage estimate of the coverage gap received from the NTN.

Paragraph 9. A method according to paragraph 7, wherein the receiving, from the NTN, an indication that the communications device is expected to enter the coverage gap before the SDT failure timer expires comprises
receiving, from the NTN, an indication of an SDT adjustment timer setting a time period based on the estimate of the coverage gap, the coverage gap having been estimated by the NTN, wherein the adjusting the commenced SDT failure timer based on an estimate of the coverage gap comprises
adjusting the commenced SDT failure timer based on the time period set by the SDT adjustment timer.

Paragraph 10. A method according to paragraph 9, wherein the time period set by the SDT adjustment timer is longer than the estimated coverage gap.

Paragraph 11. A method according to paragraph 9 or paragraph 10, wherein the receiving, from the NTN, an indication of an SDT adjustment timer setting a time period based on the estimate of the coverage gap comprises
receiving, from the NTN, an indication of an adjusted SDT failure timer maintained at the NTN, the adjusted SDT timer maintained at the NTN having been adjusted by the NTN based on the estimated coverage gap, wherein the adjusting the commenced SDT failure timer based on the time period set by the SDT adjustment timer comprises
adjusting the commenced SDT failure timer based on the indication of the adjusted SDT failure timer maintained at the NTN.

Paragraph 12. A method according to any of paragraphs 1 to 11, comprising
transmitting, to the NTN, assistance information for assisting the NTN in communicating one or more SDTs with the communications device after the coverage gap, the assistance information being transmitted by the communications device either before, during or after the coverage gap.

Paragraph 13. A method according to paragraph 12, comprising
estimating the coverage gap,
including the estimated coverage gap in the assistance information transmitted to the NTN.

Paragraph 14. A method according to paragraph 12 or paragraph 13, wherein the transmitting the assistance information to the NTN comprises
determining a location of the communications device, and
including the location of the communications device in the assistance information transmitted to the NTN.

Paragraph 15. A method according to paragraph 14, wherein determining the location of the communications device comprises
receiving a plurality of positioning reference signals from the NTN, and
determining the location of the communications device based on the plurality of positioning reference signals received from the NTN.

Paragraph 16. A method according to any of paragraphs 12 to 15, wherein the transmitting the assistance information to the NTN comprises
transmitting a Sounding Reference Signal, SRS, to the NTN on communications resources dedicated for the transmission of the SRS by the communications device.

Paragraph 17. A method according to any of paragraphs 12 to 16, wherein the transmitting the assistance information to the NTN comprises
transmitting a reserved preamble to the NTN on communications resources reserved for the transmission of the reserved preamble by the communications device.

Paragraph 18. A method according to any of paragraphs 1 to 17, wherein the commencing the SDT failure timer comprises
transmitting an SDT initiation signal, and
commencing the SDT failure timer in response to transmitting the SDT initiation signal.

Paragraph 19. A method of operating non-terrestrial network, NTN, infrastructure equipment for transmitting signals to and/or receiving signals from a communications device while the communications device is in an inactive state, the method comprising,
providing a coverage area for communicating one or more small data transmissions, SDTs, with the communications device when the communications device is located inside the coverage area, wherein the NTN infrastructure equipment can communicate the one or more SDTs with the communications device during a time period set by an SDT failure timer commenced by the communications device,
transmitting, to the communications device, information for determining that the communications device is expected to enter a coverage gap before the SDT failure timer expires, and
determining that the SDT failure timer has been adjusted by the communications device.

Paragraph 20. A method according to paragraph 19, wherein the transmitting, to the communications device, the information for determining that the communications device is expected to enter a coverage gap before the SDT failure timer expires comprises
transmitting ephemeris information regarding an orbit of one or more NTN aerial vehicles which provide the coverage area for the communications device for the communications device to estimate the coverage gap.

Paragraph 21. A method according to paragraph 19 or paragraph 20, wherein the transmitting, to the communications device, the information for determining that the communications device is expected to enter a coverage gap before the SDT failure timer expires comprises
estimating the coverage gap by the NTN infrastructure equipment, and
transmitting an indication of the estimated coverage gap to the communications device.

Paragraph 22. A method according to any of paragraphs 19 to 21, wherein the transmitting, to the communications device, the information for determining that the communications device is expected to enter a coverage gap before the SDT failure timer expires comprises
estimating the coverage gap by the NTN infrastructure equipment,
determining an SDT adjustment timer setting a time period based on the coverage gap estimated by the NTN infrastructure equipment,
transmitting an indication of the SDT adjustment timer to the communications device.

Paragraph 23. A method according to paragraph 22, wherein the time period set by the SDT adjustment timer is longer than the coverage gap.

Paragraph 24. A method according to paragraph 22 or paragraph 23, wherein the determining the SDT adjustment timer setting a time period based on the coverage gap estimated by the NTN infrastructure equipment comprises
commencing, by the NTN infrastructure equipment, an SDT failure timer maintained at the NTN infrastructure equipment,
adjusting the SDT failure timer maintained at the NTN infrastructure equipment based on the coverage gap estimated by the NTN infrastructure equipment, and
transmitting an indication of the adjusted SDT failure timer maintained at the NTN infrastructure equipment to the communications device.

Paragraph 25. A method according to paragraph 24, wherein the SDT failure timer maintained at the NTN infrastructure equipment is commenced in response to receiving an SDT initiation signal from the communications device.

Paragraph 26. A method according to any of paragraphs 19 to 25, comprising
receiving, from the communications device, assistance information for assisting the NTN infrastructure equipment in communicating one or more SDTs with the communications device after the coverage gap, the assistance information being received by the NTN infrastructure equipment either before, during or after the coverage gap, and
communicating the one or more SDTs with the communications device after the coverage gap based on the assistance information.

Paragraph 27. A method according to paragraph 26, wherein the assistance information comprises an estimate of the coverage gap estimated by the communications device.

Paragraph 28. A method according to paragraph 26 or paragraph 27, wherein the assistance information comprises a location of the communications device.

Paragraph 29. A method according to paragraph 28, comprising
transmitting a plurality of positioning reference signals to the communications device for determining the location of the communications device.

Paragraph 30. A method according to any of paragraphs 26 to 29, wherein the assistance information comprises a sounding reference signal, SRS, on communications resources dedicated for the transmission of the SRS by the communications device.

Paragraph 31. A method according to any of paragraphs 26 to 30, wherein the assistance information comprises a reserved preamble on communications resources reserved for the transmission of the reserved preamble by the communications device Paragraph 32. A method according to any of paragraphs 19 to 31, wherein the NTN infrastructure equipment is an NTN aerial vehicle.

Paragraph 33. A communications device for transmitting signals to and/or receiving signals from a non-terrestrial network, NTN, the communications device comprising,
a transmitter configured to transmit signals,
a receiver configured to receive signals, and
a controller configured in combination with the transmitter and/or the receiver, while the communications device is in the inactive state,
to commence a small data transmission, SDT, failure timer setting a time period during which the communications device can communicate one or more SDTs with the NTN when the communications device is located inside a coverage area provided by the NTN,
to determine that the communications device is expected to enter a coverage gap before the SDT failure timer expires, the coverage gap being a time period during which the communications device is located outside the coverage area provided by the NTN, and
to adjust the commenced SDT failure timer based on an estimate of the coverage gap.

Paragraph 34. A communications device according to paragraph 33, wherein the controller is configured in combination with the transmitter and/or the receiver to extend the SDT failure timer based on the estimate of the coverage gap.

Paragraph 35. A communications device according to paragraph 33 or paragraph 34, wherein the controller is configured in combination with the transmitter and/or the receiver to pause the SDT failure timer based on the estimate of the coverage gap.

Paragraph 36. A communications device according to any of paragraphs 33 to 35, wherein the controller is configured in combination with the transmitter and/or the receiver
to determine that the coverage gap has ended and, in response,
to restart the SDT failure timer.

Paragraph 37. A communications device according to any of paragraphs 33 to 36, wherein the controller is configured in combination with the transmitter and/or the receiver
to receive, from the NTN, ephemeris information regarding an orbit of one or more NTN aerial vehicles which provide the coverage area for the communications device, and
to determine that the communications device is expected to enter the coverage gap before the SDT failure timer expires based on the received ephemeris information.

Paragraph 38. A communications device according to paragraph 37, wherein the controller is configured in combination with the transmitter and/or the receiver
to estimate the coverage gap based on the received ephemeris information, and
to adjust the commenced SDT failure timer based on the coverage gap estimated by the communications device based on the received ephemeris information.

Paragraph 39. A communications device according to any of paragraphs 33 to 38, wherein the controller is configured in combination with the transmitter and/or the receiver
to receive, from the NTN, an indication that the communications device is expected to enter the coverage gap before the SDT failure timer expires.

Paragraph 40. A communications device according to paragraph 39, wherein the controller is configured in combination with the transmitter and/or the receiver
to receive the estimate of the coverage gap from the NTN, and
to adjust the commenced SDT failure timer based on the coverage estimate of the coverage gap received from the NTN.

Paragraph 41. A communications device according to paragraph 39, wherein the controller is configured in combination with the transmitter and/or the receiver
to receive, from the NTN, an indication of an SDT adjustment timer setting a time period based on the estimate of the coverage gap, the coverage gap having been estimated by the NTN, and
to adjust the commenced SDT failure timer based on the time period set by the SDT adjustment timer.

Paragraph 42. A communications device according to paragraph 41, wherein the time period set by the SDT adjustment timer is longer than the estimated coverage gap.

Paragraph 43. A communications device according to paragraph 41 or paragraph 42, wherein the controller is configured in combination with the transmitter and/or the receiver
to receive, from the NTN, an indication of an adjusted SDT failure timer maintained at the NTN, the adjusted SDT timer maintained at the NTN having been adjusted by the NTN based on the estimated coverage gap, and
to adjust the commenced SDT failure timer based on the indication of the adjusted SDT failure timer maintained at the NTN.

Paragraph 44. A communications device according to any of paragraphs 33 to 43, wherein the controller is configured in combination with the transmitter and/or the receiver
transmit, to the NTN, assistance information for assisting the NTN in communicating one or more SDTs with the communications device after the coverage gap, the assistance information being transmitted by the communications device either before, during or after the coverage gap.

Paragraph 45. A communications device according to paragraph 44, wherein the controller is configured in combination with the transmitter and/or the receiver
to estimate the coverage gap,
to include the estimated coverage gap in the assistance information transmitted to the NTN.

Paragraph 46. A communications device according to paragraph 44 or paragraph 45, wherein the controller is configured in combination with the transmitter and/or the receiver
to determine a location of the communications device, and
including the location of the communications device in the assistance information transmitted to the NTN.

Paragraph 47. A communications device according to paragraph 46, wherein the controller is configured in combination with the transmitter and/or the receiver
to receive a plurality of positioning reference signals from the NTN, and
to determine the location of the communications device based on the plurality of positioning reference signals received from the NTN.

Paragraph 48. A communications device according to any of paragraphs 44 to 47, wherein the controller is configured in combination with the transmitter and/or the receiver
transmit a Sounding Reference Signal, SRS, to the NTN on communications resources dedicated for the transmission of the SRS by the communications device.

Paragraph 49. A communications device according to any of paragraphs 44 to 48, wherein the controller is configured in combination with the transmitter and/or the receiver
to transmit a reserved preamble to the NTN on communications resources reserved for the transmission of the reserved preamble by the communications device.

Paragraph 50. A communications device according to any of paragraphs 33 to 49, wherein the controller is configured in combination with the transmitter and/or the receiver
to transmit an SDT initiation signal, and
to commence the SDT failure timer in response to transmitting the SDT initiation signal.

Paragraph 51. Non-terrestrial network, NTN, infrastructure equipment for transmitting signals to and/or receiving signals from a communications device, the NTN infrastructure equipment comprising,
a transmitter configured to transmit signals,
a receiver configured to receive signals,
a controller configured in combination with the transmitter and/or the receiver, while the communications device is in the inactive state,
to provide a coverage area for communicating one or more small data transmissions, SDTs, with the communications device when the communications device is located inside the coverage area, wherein the NTN infrastructure equipment can communicate the one or more SDTs with the communications device during a time period set by an SDT failure timer commenced by the communications device,
to transmit, to the communications device, information for determining that the communications device is expected to enter a coverage gap before the SDT failure timer expires, and
to determine that the SDT failure timer has been adjusted by the communications device.

Paragraph 52. NTN infrastructure equipment according to paragraph 51, wherein the controller is configured in combination with the transmitter and/or the receiver
to transmit ephemeris information regarding an orbit of one or more NTN aerial vehicles which provide the coverage area for the communications device for the communications device to estimate the coverage gap.

Paragraph 53. NTN infrastructure equipment according to paragraph 51 or paragraph 52, wherein the controller is configured in combination with the transmitter and/or the receiver
to estimate the coverage gap, and
to transmit an indication of the estimated coverage gap to the communications device.

Paragraph 54. NTN infrastructure equipment according to any of paragraphs 51 to 53, wherein the controller is configured in combination with the transmitter and/or the receiver
to estimate the coverage gap,
to determine an SDT adjustment timer setting a time period based on the coverage gap estimated by the NTN infrastructure equipment, and
to transmit an indication of the SDT adjustment timer to the communications device.

Paragraph 55. NTN infrastructure equipment according to paragraph 54, wherein the time period set by the SDT adjustment timer is longer than the coverage gap.

Paragraph 56. NTN infrastructure equipment according to paragraph 54 or paragraph 55, wherein the controller is configured in combination with the transmitter and/or the receiver
to commence an SDT failure timer maintained at the NTN infrastructure equipment,
to adjust the SDT failure timer maintained at the NTN infrastructure equipment based on the coverage gap estimated by the NTN infrastructure equipment, and
to transmit an indication of the adjusted SDT failure timer maintained at the NTN infrastructure equipment to the communications device.

Paragraph 57. NTN infrastructure equipment according to paragraph 56, wherein the controller is configured in combination with the transmitter and/or the receiver
to commence the SDT failure timer maintained at the NTN infrastructure equipment in response to receiving an SDT initiation signal from the communications device.

Paragraph 58. NTN infrastructure equipment according to any of paragraphs 51 to 57, wherein the controller is configured in combination with the transmitter and/or the receiver
to receive, from the communications device, assistance information for assisting the NTN infrastructure equipment in communicating one or more SDTs with the communications device after the coverage gap, the assistance information being received by the NTN infrastructure equipment either before, during or after the coverage gap, and
to communicate the one or more SDTs with the communications device after the coverage gap based on the assistance information.

Paragraph 59. NTN infrastructure equipment according to paragraph 58, wherein the assistance information comprises an estimate of the coverage gap estimated by the communications device.

Paragraph 60. NTN infrastructure equipment according to paragraph 58 or paragraph 59, wherein the assistance information comprises a location of the communications device.

Paragraph 61. NTN infrastructure equipment according to paragraph 60, wherein the controller is configured in combination with the transmitter and/or the receiver
to transmit a plurality of positioning reference signals to the communications device for determining the location of the communications device.

Paragraph 62. NTN infrastructure equipment according to any of paragraphs 58 to 61, wherein the assistance information comprises a sounding reference signal, SRS, on communications resources dedicated for the transmission of the SRS by the communications device.

Paragraph 63. NTN infrastructure equipment according to any of paragraphs 58 to 62, wherein the assistance information comprises a reserved preamble on communications resources reserved for the transmission of the reserved preamble by the communications device

Paragraph 64. NTN infrastructure equipment according to any of paragraphs 51 to 63, wherein the NTN infrastructure equipment is an NTN aerial vehicle.

Paragraph 65. Circuitry for a communications device for transmitting signals to and/or receiving signals from a non-terrestrial network, NTN, the circuitry comprising,
transmitter circuitry configured to transmit signals,
receiver circuitry configured to receive signals, and
controller circuitry configured in combination with the transmitter circuitry and/or the receiver circuitry, while the communications device is in the inactive state,
to commence a small data transmission, SDT, failure timer setting a time period during which the communications device can communicate one or more SDTs with the NTN when the communications device is located inside a coverage area provided by the NTN,
to determine that the communications device is expected to enter a coverage gap before the SDT failure timer expires, the coverage gap being a time period during which the communications device is located outside the coverage area provided by the NTN, and
to adjust the commenced SDT failure timer based on an estimate of the coverage gap.

Paragraph 66. Circuitry for non-terrestrial network, NTN, infrastructure equipment for transmitting signals to and/or receiving signals from a communications device, the circuitry comprising,
transmitter circuitry configured to transmit signals,
receiver circuitry configured to receive signals, and
controller circuitry configured in combination with the transmitter circuitry and/or the receiver circuitry, while the communications device is in the inactive state,
to provide a coverage area for communicating one or more small data transmissions, SDTs, with the communications device when the communications device is located inside the coverage area, wherein the NTN infrastructure equipment can communicate the one or more SDTs with the communications device during a time period set by an SDT failure timer commenced by the communications device,
to transmit, to the communications device, information for determining that the communications device is expected to enter a coverage gap before the SDT failure timer expires, and
to determine that the SDT failure timer has been adjusted by the communications device.

Paragraph 67. A wireless communications system comprising a communications device according to paragraph 33 and non-terrestrial network, NTN, infrastructure equipment according to paragraph 51.

Paragraph 68. A computer program comprising instructions which, when loaded onto a computer, cause the computer to perform a method according to any of paragraphs 1 to 32.

Paragraph 69. A non-transitory computer-readable storage medium storing a computer program according to paragraph 68.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1]TR 38.811 V15.4.0, “Study on New Radio (NR) to support non terrestrial networks (Release 15)”, 3rd Generation Partnership Project, October 2020.
[2]Holma H. and Toskala A, “LTE for UMTS OFDMA and SC-FDMA based radio access”, John Wiley and Sons, 2009.
[3]RP-192330, “New work item: 2-step RACH for NR,” ZTE Corporation, 3GPP TSG RAN Meeting #85.
[4]RP-192324, “Revised WID: Support of NR Industrial Internet of Things (IoT),” Nokia, Nokia Shanghai Bell, 3GPP TSG RAN Meeting #85.
[5]RP-191575, “NR-based Access to Unlicensed Spectrum,” Qualcomm, Inc., 3GPP TSG RAN Meeting #84.
[6]RP-193252, “New Work Item on NR small data transmission in INACTIVE state,” ZTE Corporation, 3GPP TSG RAN Meeting #86.
[7]TR 38.821, “Solutions for NR to support non-terrestrial networks”, Rel-16.
[8]TR 38.840, “Study on User Equipment (UE) power saving in NR”, Rel-16.

What is claimed is:

1. A method of operating a communications device for transmitting signals to and/or receiving signals from a non-terrestrial network, NTN, while the communications device is in an inactive state, the method comprising,
commencing a small data transmission, SDT, failure timer setting a time period during which the communications device can communicate one or more SDTs with the NTN when the communications device is located inside a coverage area provided by the NTN,
determining that the communications device is expected to enter a coverage gap before the SDT failure timer expires, the coverage gap being a time period during which the communications device is located outside the coverage area provided by the NTN, and
adjusting the commenced SDT failure timer based on an estimate of the coverage gap.

2-18. (canceled)

19. A method of operating non-terrestrial network, NTN, infrastructure equipment for transmitting signals to and/or receiving signals from a communications device while the communications device is in an inactive state, the method comprising,
providing a coverage area for communicating one or more small data transmissions, SDTs, with the communications device when the communications device is located inside the coverage area, wherein the NTN infrastructure equipment can communicate the one or more SDTs with the communications device during a time period set by an SDT failure timer commenced by the communications device,
transmitting, to the communications device, information for determining that the communications device is expected to enter a coverage gap before the SDT failure timer expires, and
determining that the SDT failure timer has been adjusted by the communications device.

20-32. (canceled)

33. A communications device for transmitting signals to and/or receiving signals from a non-terrestrial network, NTN, the communications device comprising,
a transmitter configured to transmit signals,
a receiver configured to receive signals, and
a controller configured in combination with the transmitter and/or the receiver, while the communications device is in the inactive state,
to commence a small data transmission, SDT, failure timer setting a time period during which the communications device can communicate one or more SDTs with the NTN when the communications device is located inside a coverage area provided by the NTN,
to determine that the communications device is expected to enter a coverage gap before the SDT failure timer expires, the coverage gap being a time period during which the communications device is located outside the coverage area provided by the NTN, and
to adjust the commenced SDT failure timer based on an estimate of the coverage gap.

34. A communications device according to claim 33, wherein the controller is configured in combination with the transmitter and/or the receiver to extend the SDT failure timer based on the estimate of the coverage gap.

35. A communications device according to claim 33, wherein the controller is configured in combination with the transmitter and/or the receiver to pause the SDT failure timer based on the estimate of the coverage gap.

36. A communications device according to claim 33, wherein the controller is configured in combination with the transmitter and/or the receiver
to determine that the coverage gap has ended and, in response,
to restart the SDT failure timer.

37. A communications device according to claim 33, wherein the controller is configured in combination with the transmitter and/or the receiver
to receive, from the NTN, ephemeris information regarding an orbit of one or more NTN aerial vehicles which provide the coverage area for the communications device, and
to determine that the communications device is expected to enter the coverage gap before the SDT failure timer expires based on the received ephemeris information.

38. A communications device according to claim 37, wherein the controller is configured in combination with the transmitter and/or the receiver
to estimate the coverage gap based on the received ephemeris information, and
to adjust the commenced SDT failure timer based on the coverage gap estimated by the communications device based on the received ephemeris information.

39. A communications device according to claim 33, wherein the controller is configured in combination with the transmitter and/or the receiver
to receive, from the NTN, an indication that the communications device is expected to enter the coverage gap before the SDT failure timer expires.

40. A communications device according to claim 39, wherein the controller is configured in combination with the transmitter and/or the receiver
to receive the estimate of the coverage gap from the NTN, and
to adjust the commenced SDT failure timer based on the coverage estimate of the coverage gap received from the NTN.

41. A communications device according to claim 39, wherein the controller is configured in combination with the transmitter and/or the receiver
to receive, from the NTN, an indication of an SDT adjustment timer setting a time period based on the estimate of the coverage gap, the coverage gap having been estimated by the NTN, and
to adjust the commenced SDT failure timer based on the time period set by the SDT adjustment timer.

42. A communications device according to claim 41, wherein the time period set by the SDT adjustment timer is longer than the estimated coverage gap.

43. A communications device according to claim 41, wherein the controller is configured in combination with the transmitter and/or the receiver
to receive, from the NTN, an indication of an adjusted SDT failure timer maintained at the NTN, the adjusted SDT timer maintained at the NTN having been adjusted by the NTN based on the estimated coverage gap, and
to adjust the commenced SDT failure timer based on the indication of the adjusted SDT failure timer maintained at the NTN.

44. A communications device according to claim 33, wherein the controller is configured in combination with the transmitter and/or the receiver
transmit, to the NTN, assistance information for assisting the NTN in communicating one or more SDTs with the communications device after the coverage gap, the assistance information being transmitted by the communications device either before, during or after the coverage gap.

45. A communications device according to claim 44, wherein the controller is configured in combination with the transmitter and/or the receiver
to estimate the coverage gap,
to include the estimated coverage gap in the assistance information transmitted to the NTN.

46. A communications device according to claim 44, wherein the controller is configured in combination with the transmitter and/or the receiver
to determine a location of the communications device, and
including the location of the communications device in the assistance information transmitted to the NTN.

47. A communications device according to claim 46, wherein the controller is configured in combination with the transmitter and/or the receiver
to receive a plurality of positioning reference signals from the NTN, and
to determine the location of the communications device based on the plurality of positioning reference signals received from the NTN.

48. A communications device according to claim 44, wherein the controller is configured in combination with the transmitter and/or the receiver
transmit a Sounding Reference Signal, SRS, to the NTN on communications resources dedicated for the transmission of the SRS by the communications device.

49. A communications device according to claim 44, wherein the controller is configured in combination with the transmitter and/or the receiver
to transmit a reserved preamble to the NTN on communications resources reserved for the transmission of the reserved preamble by the communications device.

50. A communications device according to claim 33, wherein the controller is configured in combination with the transmitter and/or the receiver
to transmit an SDT initiation signal, and
to commence the SDT failure timer in response to transmitting the SDT initiation signal.

51-69. (canceled)
